(19) United States
(12) Patent Application Publication
(10) Pub. No.: US 2008/0255918 A1
(43) Pub. Date: Oct. 16, 2008

(54) Ontological representation of knowledge

(75) Inventor: Suresh Madhavan, Foster City, CA (US)

Correspondence Address: PERKINS COIE LLP, P.O. BOX 1208, SEATTLE, WA, 98111-1208, US

(73) Assignee: PointCross, Inc., Foster City, CA (US)

(21) Appl. No.: 12/080,592

(22) Filed: Apr. 3, 2008

Related U.S. Application Data
(63) Continuation of application No. 09/765,993, filed on Jan. 20, 2001, now abandoned.

(51) Int. Cl. G06Q 10/00

(52) U.S. Cl. 705/9; 705/7

(57) ABSTRACT

A technique for representing a project over a network involves developing requirements for the project and linking responses to the requirements. A user associated with the project is automatically linked to project data in accordance with the user's role in the project. The project data includes the requirements, responses and other data.

### CROSS-REFERENCE TO RELATED APPLICATIONS

This application is a continuation application and claims priority to U.S. patent application Ser. No. 09/765,993, filed Jan. 20, 2001, and entitled “Integrated Project Office” by Suresh Madhavan, which is incorporated by reference.

### BACKGROUND

Large projects in the energy and construction business are financed, produced, engineered, built, commissioned, operated and maintained by different companies at different times in the project lifecycle, and by people from different parts of the world, possibly in very remote locations. A project conceived, designed, built and operated by a single company in the same country or state, let alone city, is a very rare exception. These projects, at any phase in their lifecycle, can be treated as a business enterprise in which people and companies participate with assigned responsibilities and roles. They develop engineering specifications, analyze requirements, communicate, develop project estimations, access libraries, conduct risk analysis, and execute all the other work that a project engineer, business development, procurement or executive manager might perform on a project.

### BRIEF DESCRIPTION OF THE DRAWINGS

FIG. 1 illustrates, in a flow chart, a method for presenting a project over a network using a project office.

FIG. 2 illustrates, in a block diagram, a system for representing the project of FIG. 1 over a network using the project office.

FIG. 3 illustrates, in a state diagram, a method for creating requirements and responses to the requirements of the project of FIG. 1 using the project office.

FIG. 4 illustrates, in a block diagram, the project of FIG. 1 created by the method of FIG. 3.

FIG. 5 illustrates, in a block diagram, software components of the system of FIG. 2.

FIGS. 6, 7, and 8 illustrate, in records, data stored in the databases of FIG. 2.

FIG. 9 illustrates a web page for representing the organization of members assigned to the project in a hierarchical tree.

FIG. 10 illustrates a web page for representing the requirements of the project in a hierarchical tree.

FIG. 11A illustrates, in a flow chart, a method for assigning a member to a node of the hierarchical tree of FIG. 10.

FIG. 11B illustrates a web page for assigning the member to the node.

FIG. 12A illustrates, in a flow chart, a method for identifying risks to a node of the hierarchical tree of FIG. 10.

FIG. 12B illustrates a web page for identifying the risk to the node.

FIG. 13A illustrates, in a flow chart, a method for system engineering a node of the hierarchical tree of FIG. 10.

FIG. 13B illustrates a web page for system engineering the node.

FIG. 14A illustrates, in a flow chart, a method for providing descriptions of a node of the hierarchical tree of FIG. 10.

FIG. 14B illustrates a web page for providing descriptions of the node.

FIG. 15A illustrates, in a flow chart, a method for holding conferences in the context of a node of the hierarchical tree of FIG. 10.

FIGS. 15B, 15C, and 15D illustrate web pages for holding conferences in the context of the node.

FIG. 16A illustrates, in a flow chart, a method for sending threaded messages in the context of a node of the hierarchical tree of FIG. 10.

FIG. 16B illustrates a web page for sending threaded messages in the context of the node.

FIG. 17A illustrates, in a flow chart, a method for attaching documents to a node of the hierarchical tree of FIG. 10.

FIG. 17B illustrates a web page for attaching documents to the node.

FIG. 18A illustrates, in a flow chart, a method for calculating the estimated cost of the project.

FIG. 18B illustrates a web page for calculating the estimated cost the project.

FIG. 19A illustrates, in a flow chart, a method for importing or exporting the project.

FIG. 19B illustrates a web page for importing or exporting the project and the estimated cost of the project.

FIG. 20A illustrates, in a flow chart, a method for linking a response to a requirement of the project.

FIG. 20B illustrates a web page for linking the response to the requirement.

FIG. 21 illustrates a web page for selecting a project.

FIG. 22 illustrates a web page for alerting the members of messages of FIG. 16A.

FIG. 23 illustrates a web page including the buttons to call the tools of the project office of FIG. 2.

### DETAILED DESCRIPTION

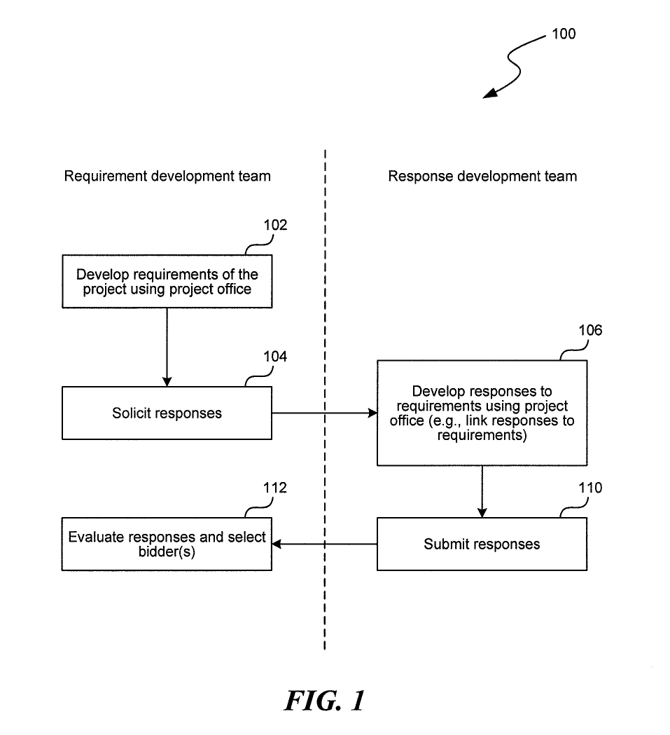

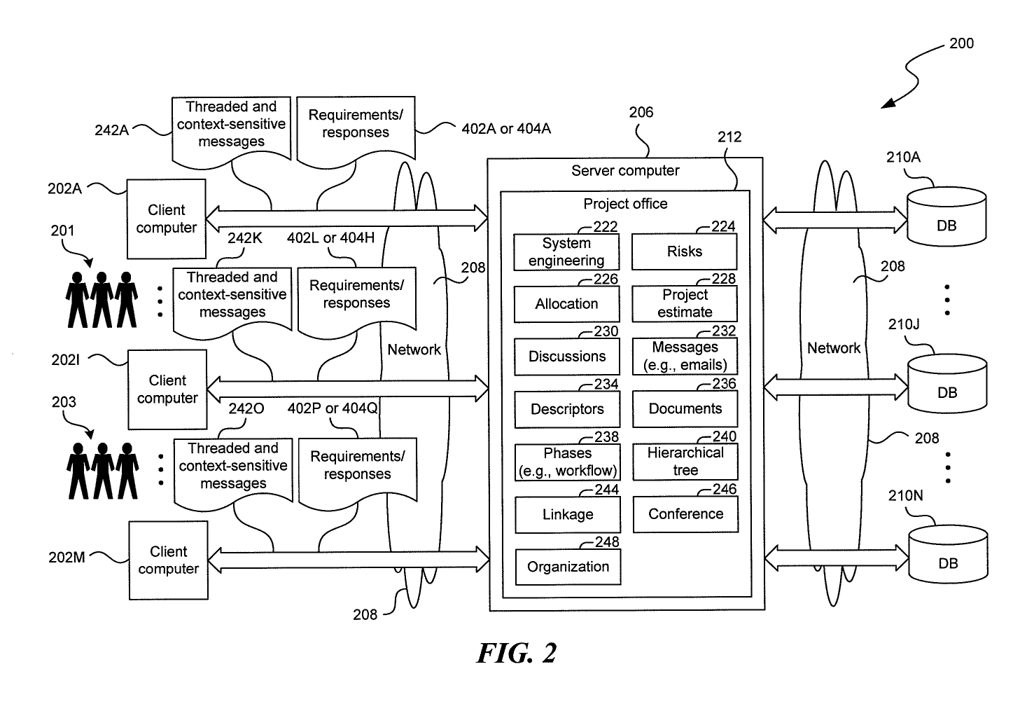

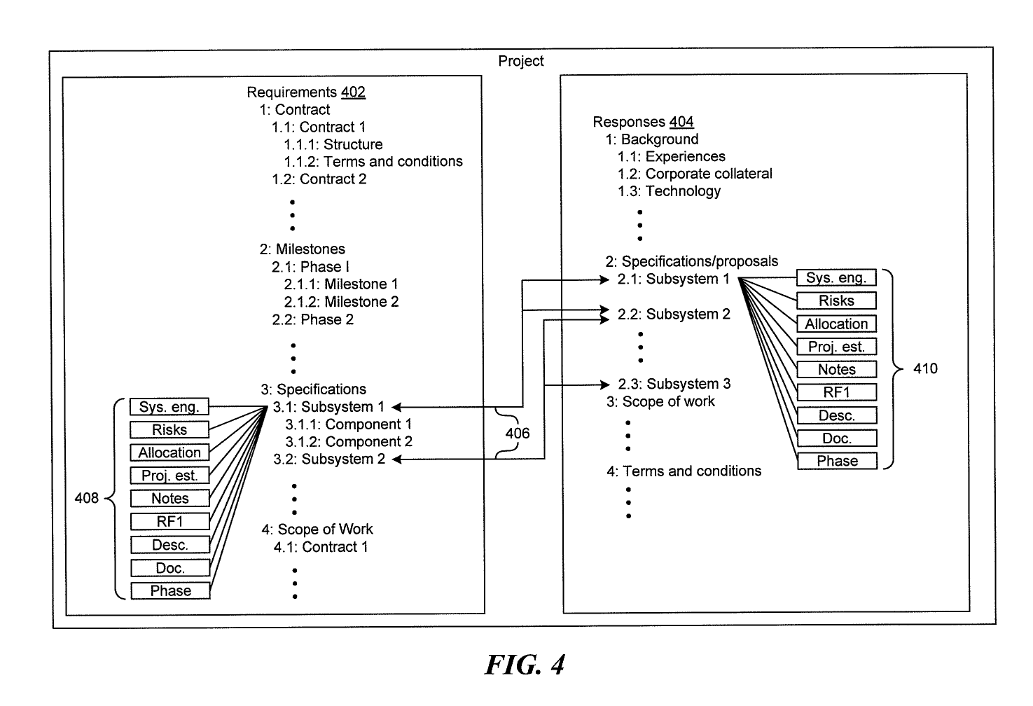

A method 100 (FIG. 1) is provided to create and solicit bids for a project over a network. In action 102, members 201 (FIG. 2) of a requirement development team use one or more of client computers 202A . . . 202I . . . 202M (A≦I≦M, where M is the number of client computers) in a system 200 to access a project office software 212 on a server computer 206 to create and define requirements 402A . . . 402L . . . 402P (FIGS. 2 and 4; A≦L≦P, where P is the number of requirements) of a project. Requirements 402A-402P (collectively “requirements 402”) are the project objectives including tasks, milestones, deliverable items, procured items, and specifications. Specifications include both technical and commercial specifications. Commercial specifications include contracts, applicable laws, business rules and directives.

Server computer 206 (FIG. 2) saves requirements 402 in one or more databases 210A . . . 210J . . . 210N (A≦J≦N, where N is the total number of databases). Members 201 have varying levels of authority and include employees and independent contractors of an individual or entity that owns the project (“project owner”). Project owner includes companies such as Chevron, Shell, and SBC.

Members 201 use tools (e.g., modules) in software 212 to create and define requirements 402. Initially, members 201 use a tool 240 to create requirements 402 in a hierarchical tree structure (analogous to file structure displayed by Microsoft Window Explorer). Each of requirements 402 in the tree structure is referred to as a node or element. After selecting a node, members 201 can use other tools (described later) to define detailed information 408 (FIG. 4) about the nodes.

Members 201 can use a tool 232 (FIG. 2) to send messages 242A . . . 242K . . . 242O (A≦K≦O, where O is the number of messages) to each other to discuss a selected node. Server computer 206 saves the threads of messages 242A-242O (collectively “messages 242”) in one or more databases 210A-210N (collectively “databases 210”). In other words, server computer 206 maintains records of the originating messages and replies to those messages. Server computer 206 also saves messages 242 in the context of the nodes from which messages originated (“originating nodes”). In other words, server computer maintains records of the originating nodes of the messages (e.g., by saving in a record of the message an identification of the originating node as a key to the record).

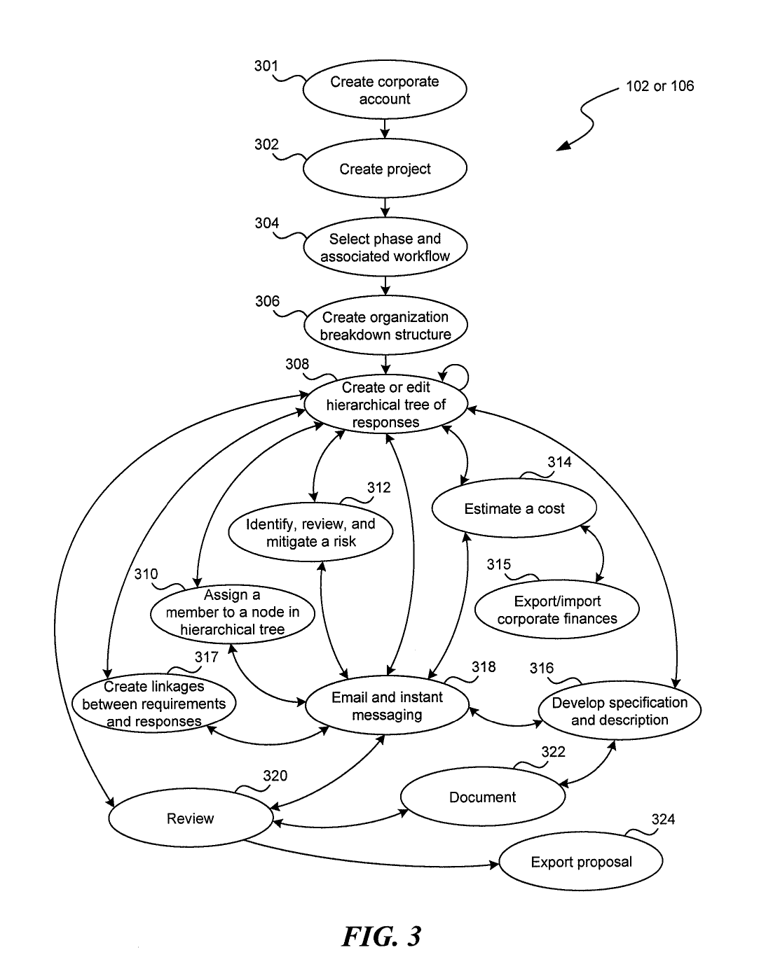

When one of members 201 views a message 242, server computer 206 transmits message 242 with a graphical representation of its thread and originating node to client computer 202 for display to member 201. Server computer 206 can also load all detailed information 408 related to the originating node in memory for the member to quickly access. Accordingly, members 201 communicate to each other in “threaded” and “context-sensitive” messages 242. Action 102 and the tools of software 212 are further described later in reference to FIG. 3.

In action 104 (FIG. 1), the requirement development team solicits responses 404A . . . 404H . . . 404Q (A≦H≦Q, where Q is the number of responses) from one or more individuals or entities (“bidders”) that normally bid for projects. Bidders include companies such as Halliburton, Bechtel, and Fluor Daniel. The requirement development team uses one or more client computers 202A-202M (collective “client computers 202”) to cause server computer 206 to send emails or other forms of notification to invite the bidders to view requirements 402 and submit responses 404A-404Q (collectively “responses 404”) to requirements 402.

In action 106 (FIG. 1), members 203 (FIG. 2) of a response development team use one or more client computers 202 to access project office software 212 on server computer 206 to create and define responses 404 to requirements 402. Members 203 have varying levels of authority and include employees and independent contractors of a bidder. Server computer 206 saves responses 404 in one or more of databases 210.

Members 203 create and define responses 404 in the same manner that members 201 create and define requirements 402. For example, members 203 use tools in software 212 to create a hierarchical list of responses 404, to define detailed information 410 of each of responses 404, and to communicate with each other in threaded and context sensitive messages 242. Members 203 also use a tool 244 to link each of responses 404 to one or more of requirements 402. Server computer 206 saves links 406 (FIG. 4) between responses 404 and requirements 402 in one or more databases 210.

In action 110 (FIG. 1), the response development team submits responses 404 to the requirement development team. The response development team uses one of client computers 202 to cause server computer 206 to send emails or other forms of notification to prompt the requirement development team to view responses 404.

In action 112, members 201 evaluate responses 404 and selects one or more bidders to carry out the project. Members 201 use one or more of client computers 202 to access software 212 on server computer 206 to view the link 406 between requirements 402 and responses 404 to determine if responses 404 comply with requirements 402. Members 201 can also use all the various tools of software 212 to view both detailed information 408 and 410.

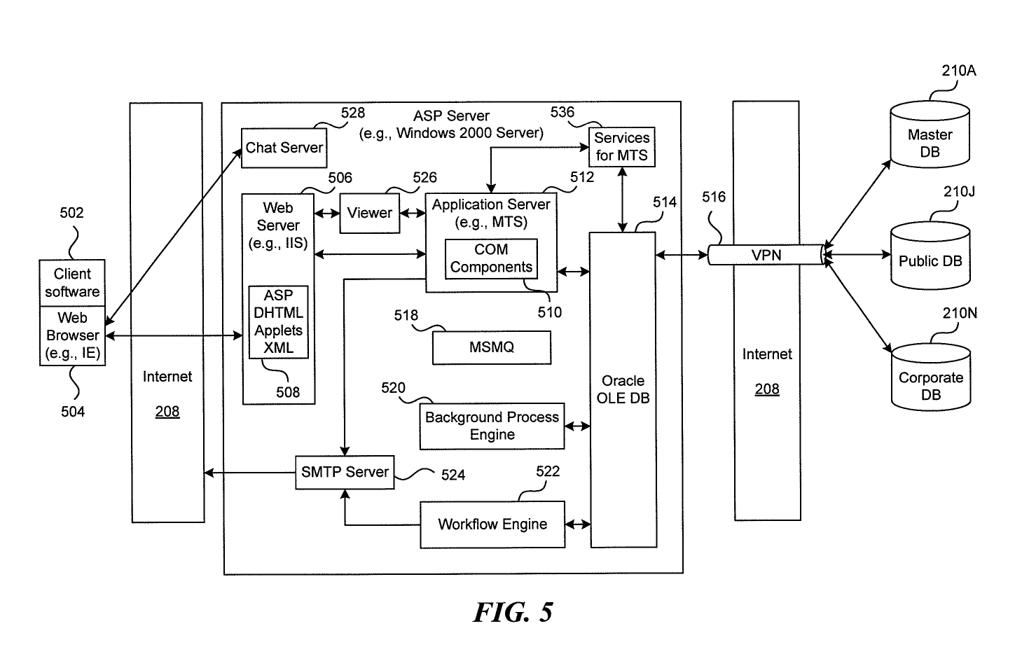

FIG. 5A illustrates one implementation of system 200. Members 201 and 203 use a client software 502 and a web browser 504 executed on client computers 202 (not shown in FIG. 5A) to access a web server 506 executed on server computer 206 (not shown in FIG. 5A) over network 208. Client software 502, web browser 504, and web server 506 are, e.g., an OLE control extension (OCX) program module, Microsoft Internet Explorer, and Microsoft Internet Information Server (IIS), respectively. Network 208 includes local area network, Intranet, and the Internet. Web server 506 delivers (e.g., serves up) Active Server Pages (ASP), dynamic hypertext markup language (DHTML) pages, applets, and extended markup language (XML) files (collectively shown as “508”) to web browser 504.

Web server 506 passes calls (e.g., requests for service of a program) from client software 502 and ASP web pages to component object model (COM) components 510 that are the tools of software 212. COM components 510 are, e.g., ActiveX Server Components. A transaction server 512 scales the processes of COM components 510 for multiple users and access the required data in databases 210. Transaction server 510 is, e.g., Microsoft Transaction Server (MTS). COM components 510 use a database interface 514 to read to and write from (e.g., access) databases 210. COM components 510 can also use service COM components 530 (e.g., Oracle MTS services) that are specific to the transaction server (e.g., MTS) to access interface 514.

Interface 514 and databases 210 are, e.g., an Oracle OLE Database COM component and Oracle 8 is, respectively. Interface 514 is connected to databases 210 through a virtual private network (VPN) 516 over network 208. One skilled in the art understands that databases 210 can be located anywhere and the records for a project can be stored on separate and individual databases 210. For example, account information of users can be kept on a master database of a provider of software 212 while project information can be kept on a public database of the provider or a private database of a project owner or a bidder shielded behind a firewall.

COM components 510 also use a messaging middleware 518 that manages traffic to databases 210 by queuing low priority messages to a background process engine 520 that writes to databases 210. Low priority messages include instructions and data for tasks that can be done later because the user is not waiting for a response. Messaging middleware 518 is, e.g., Microsoft Message Queue Server (MSMQ). COM components 510 and a work flow engine 522 (e.g., a COM component) use a simple mail transfer protocol (SMTP) server 524 to send conventional emails over network 208 to alert members 201 and 203 of certain events (described later).

Members 201 and 203 can use web browser 504 executed on client computers 202 to request documents stored in databases 210. If one of client computers 202 do not have the appropriate local software to view the document, a server-based document viewing software 526 is used to convert the document into an image for delivery to and display by web browser 504. Server 526 is, e.g., a Brava! Server available from Informative Graphics Corporation (IGC) of Phoenix, Ariz. Members 201 and 203 can use web browser and an applet to participate in online conferences hosted by a chat server 528 on server computer 206.

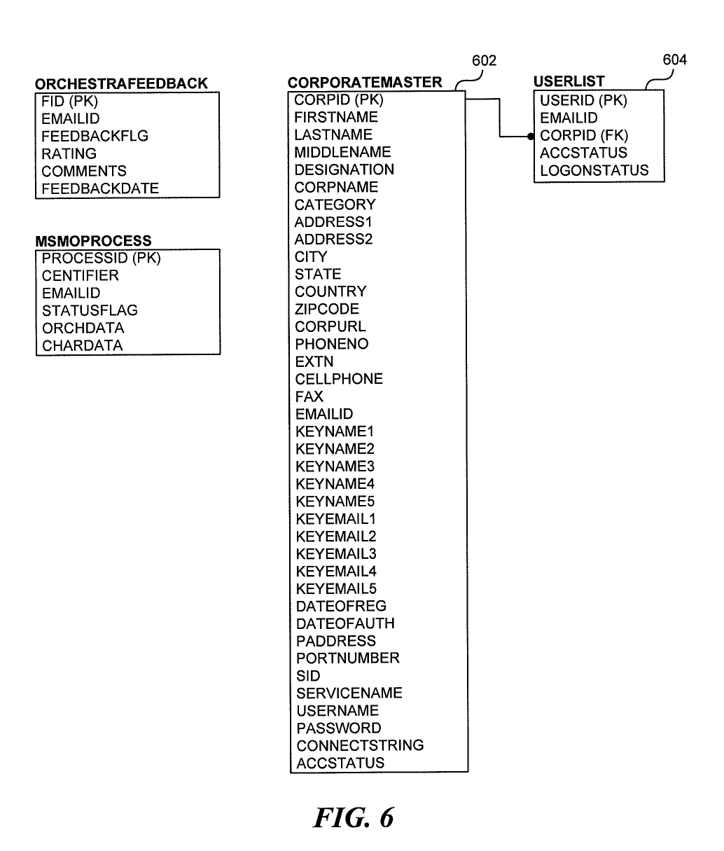

FIG. 3 illustrates the details of action 102 in a state diagram. In state 301, a member representing the project owner (e.g., an executive) optionally creates a corporate account with server computer 206 if the project owner is not registered to access server computer 206. The executive can use client computers 202I to send registration information to server computer 206 over network 208. Alternatively, the executive can send registration information by telephone or mail to a customer representative that enters the registration information into server computer 206. In either case, server computer 206 saves the registration information in a record 602 (FIG. 6) in one or more of databases 210. Record 602 includes a corporate ID (e.g., primary key), corporate contact information, IDS of users with accounts that have greater authority over other users (e.g., executive and manager accounts). After creating the corporate account, the executive uses client computer 202I to send a list of users (e.g., a “corporate list”) that are part of the owner to server computer 206. Server computer 206 saves the corporate list in a record 604 in one or more of databases 210 and details for the users in one or more record 704.

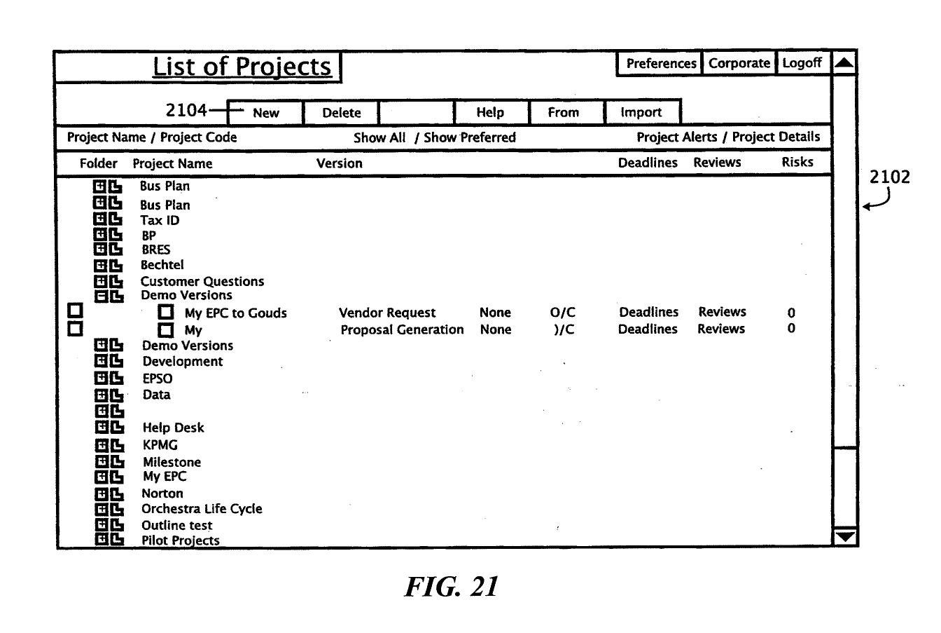

After a user logs into server computer 206, server computer 206 sends either a web page 2102 (FIG. 21) to client computer 202I. Web page 2102 includes a list of all the projects of a project owner organized in project folders. Web page 2102 also includes buttons for the user to add, delete, edit (e.g., the profile of the project), export, and import projects. To view the details of a project, the user selects one of the projects.

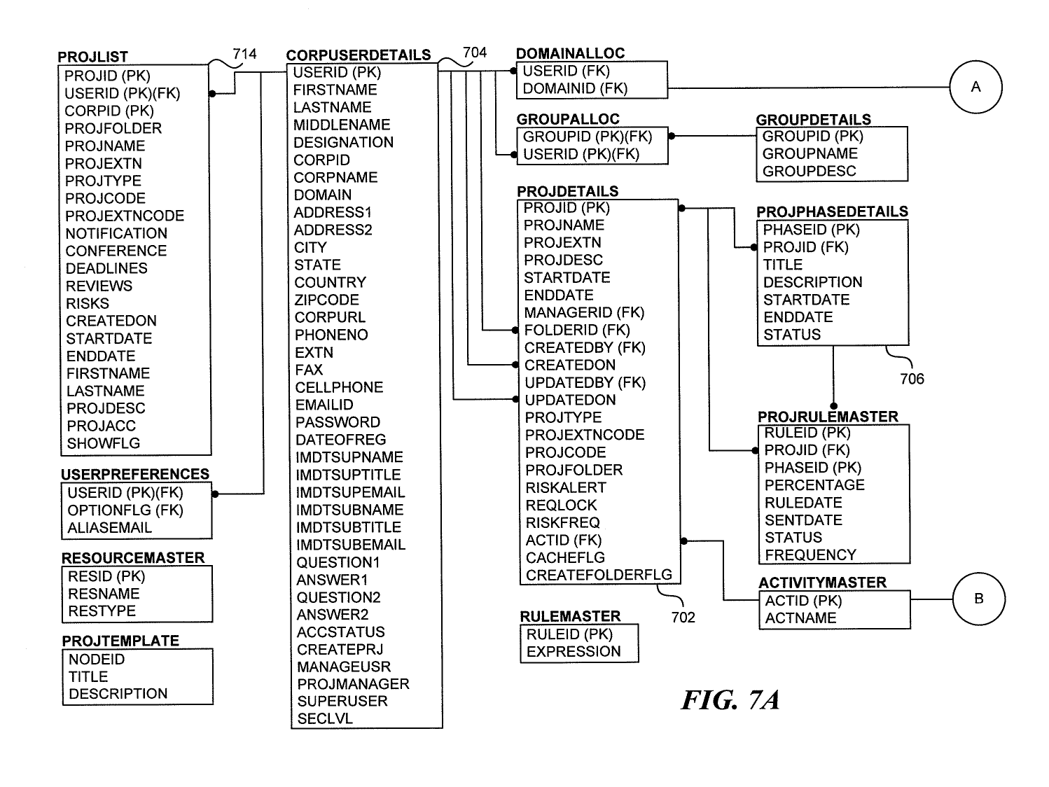

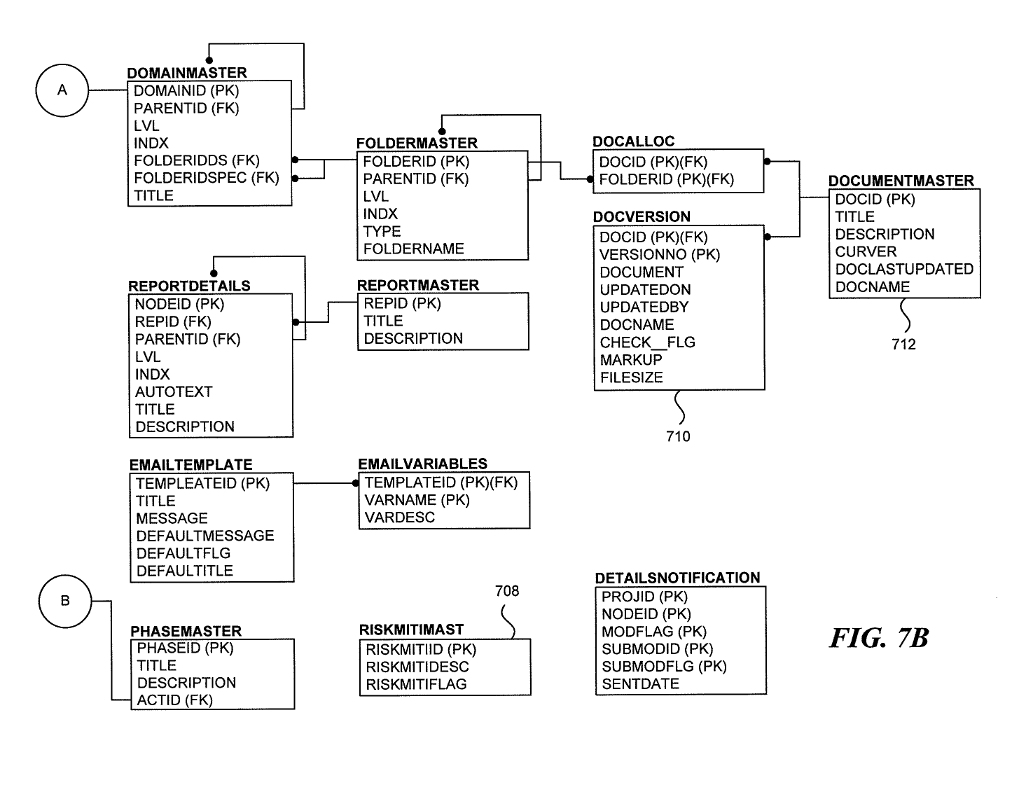

In state 302 (FIG. 3), one of members 201 (e.g., a manager) creates a project. For example, the manager selects a new button 2104 on web page 2102. The manager uses client computers 202I to send general project information to server computer 206. Server computer 206 saves the project information in a record 702 (FIG. 7) in one or more of databases 210. Record 702 includes a project ID (e.g., primary key), a project name, a project description, an ID of the manager (e.g., foreign key), and flags indicating the status of the project (e.g., whether there are any alerts for the project).

In state 304 (FIG. 3), the manager selects a phase that best describes the project and associates a workflow process with the project. The phase describes the stage of the project in its lifecycle and includes concept to bid, invitation to bid, bid assessment, proposal preparation, detailed project scoping, project execution, and commissioning. Please note that responses created for a project in one phase can become the requirements of a next phase that must be met by the bidder. Similarly, the bidder can use one or more parts of the responses as requirements for subcontractors and independent consultants.

The workflow process sends out alerts when manually triggered or automatically triggered by events specified by date, time, and action. For example, the manager provides (1) the start and end date of the project, (2) the dates/times of milestones and deliverables, (3) the types of alerts (conventional email and messages 242), and (4) the recipient of the alerts. Server computer 206 saves these information in a record 706 (FIG. 7) of one or more databases 210. Server computer 206 periodically queries record 706 and sends out alerts via workflow engine 522. Table 1 provides the file names of software on client computer 202I (e.g., ASP pages and ActiveX controls) and server computer 206 (e.g., classes of COM components) that performs the above actions.

TABLE 1

| Client computer | Server computer |
|---|---|
| Workflow.asp | Phases.cls |

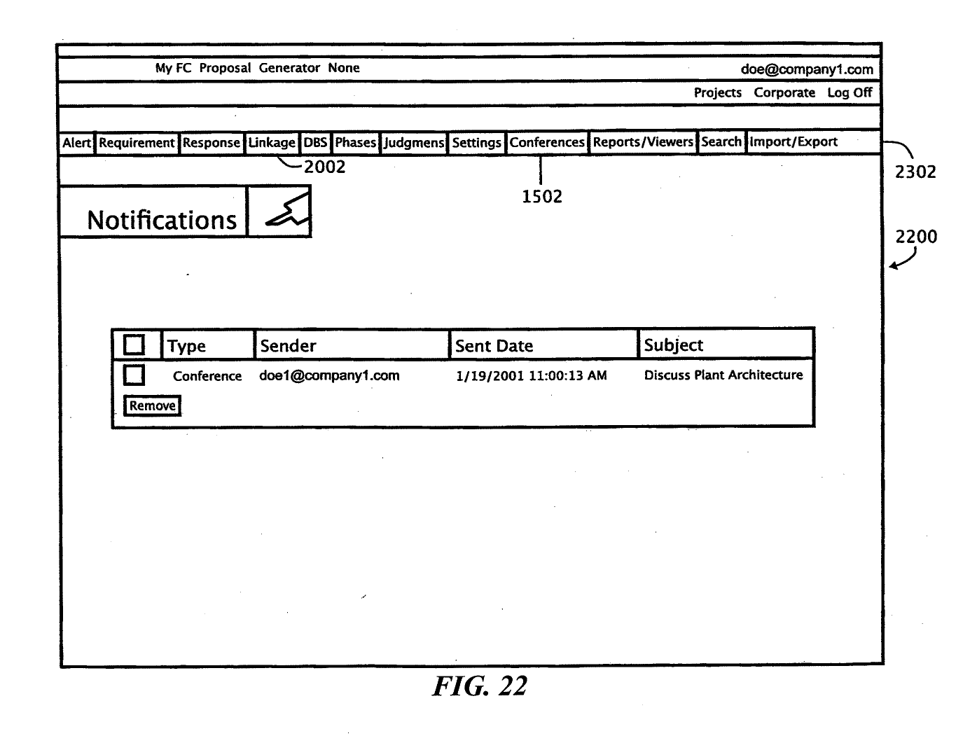

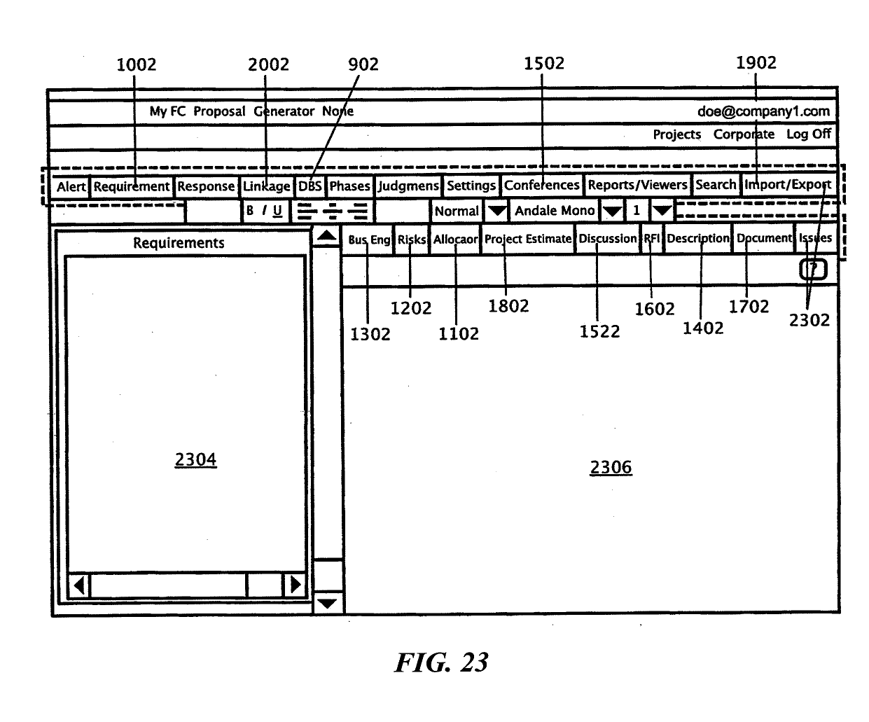

After a user selects a project from web page 2102, server computer 206 sends either a web page 2200 (FIG. 22) or 2300 (FIG. 23) to client computer 202I. Web page 2300 is the basic screen that the user sees. Web page 2200 includes menus 2302 that includes the tools of software 212. Web page 2200 also includes frames 2304 and 2306 where the user interacts with the tools. Generally, requirements 402 or responses 404 are displayed in frame 2304 while interfaces to the tools of software 212 are displayed in frame 2306.

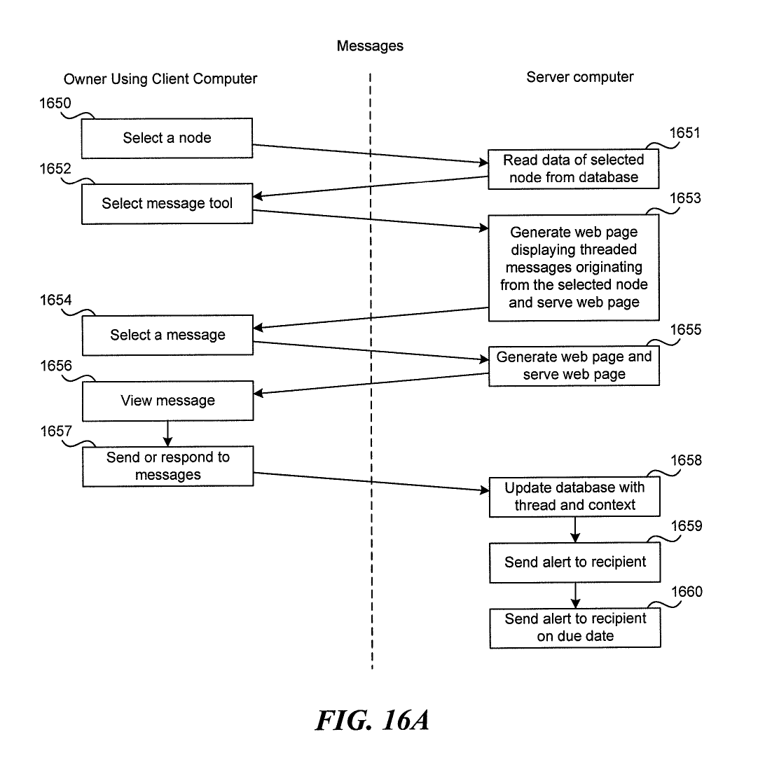

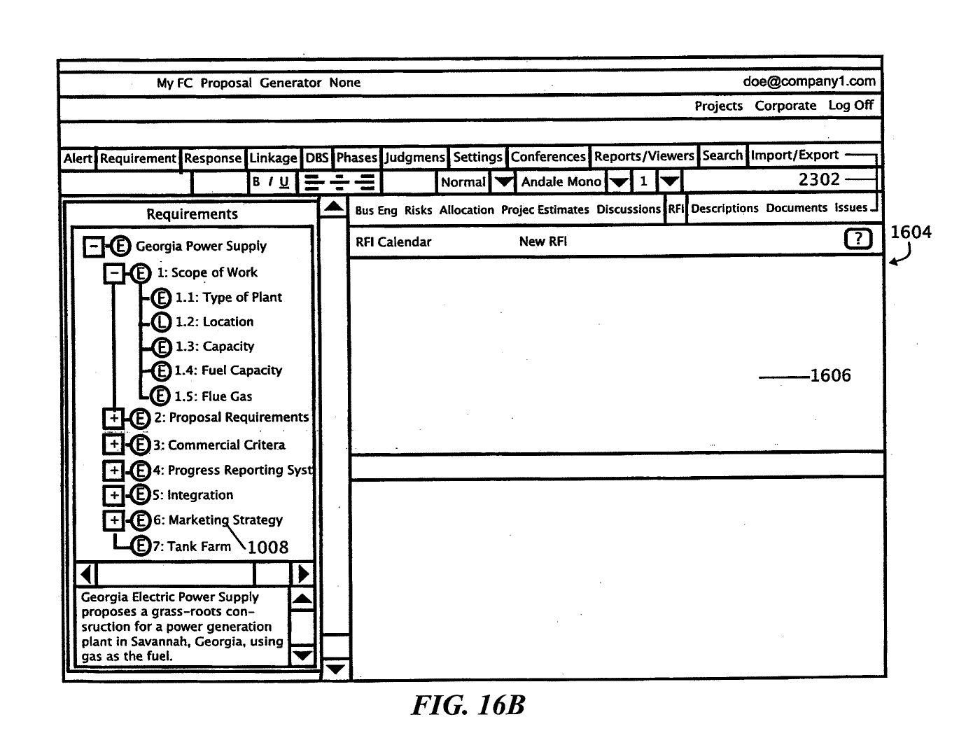

Web page 2300 includes a list of notifications of messages to the user. Server computer 206 sends web page 2300 to the user when the user has messages (described later in reference to FIGS. 16A and 16B). Web page 2300 includes a list of notifications of the messages. The user can view the messages by selecting one of the notifications.

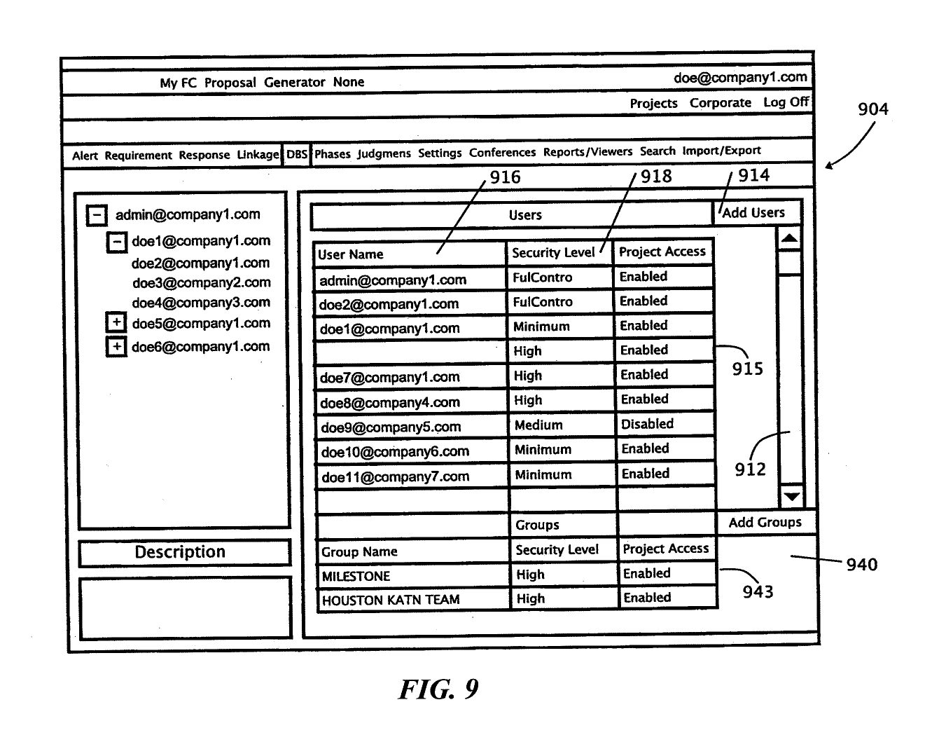

In state 306 (FIG. 3), the manager represents the organization of members 201 assigned to the project using a tool 248 named “Organization”. The manager can (1) add and delete users and groups of users to the project, and (2) arrange the users and groups in a hierarchical tree 908 (FIG. 9; e.g., an organization breakdown structure or OBS). Only members 201 with executive and manager account may create the hierarchical tree 908.

In one embodiment, the manager selects tool 248. For example, the manager selects button 902 (FIG. 23). In response, server computer 206 generates and transmits a web page 904 (FIG. 9) for display on client computer 202I. A frame 906 includes a hierarchical tree 908 where the nodes represent members 201 assigned to the project. In a first time use of tool 248, hierarchical tree 908 will contain only a root node. The manager defines tree 908 by adding parent and child nodes to tree 908.

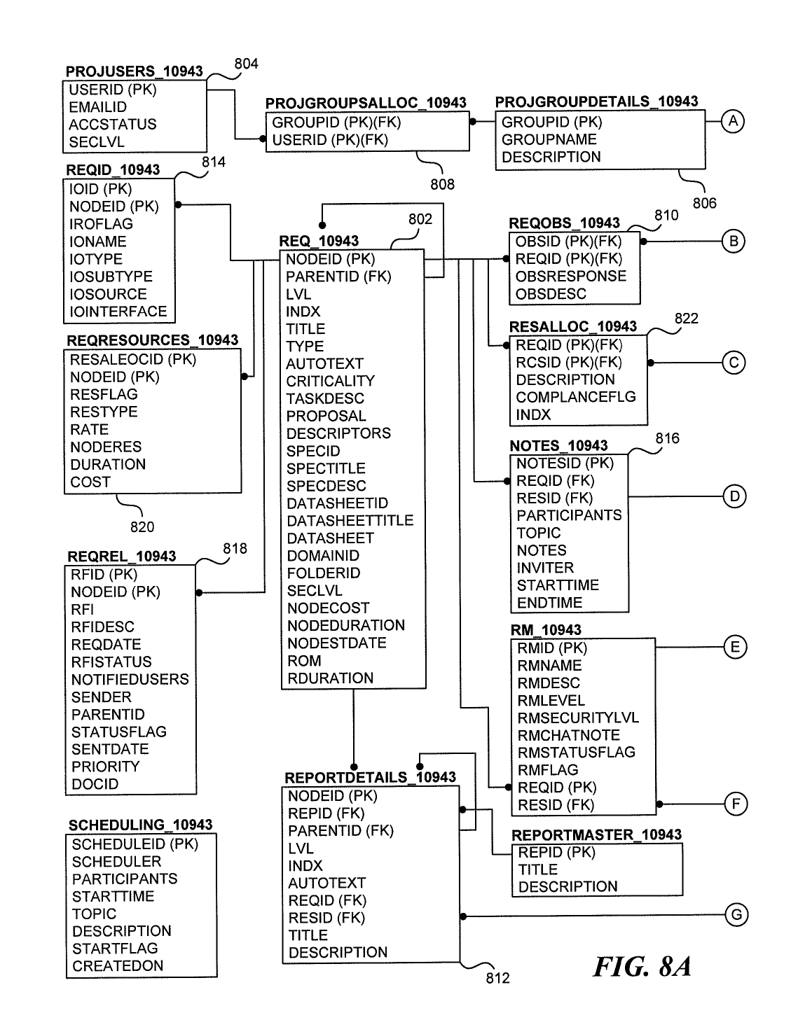

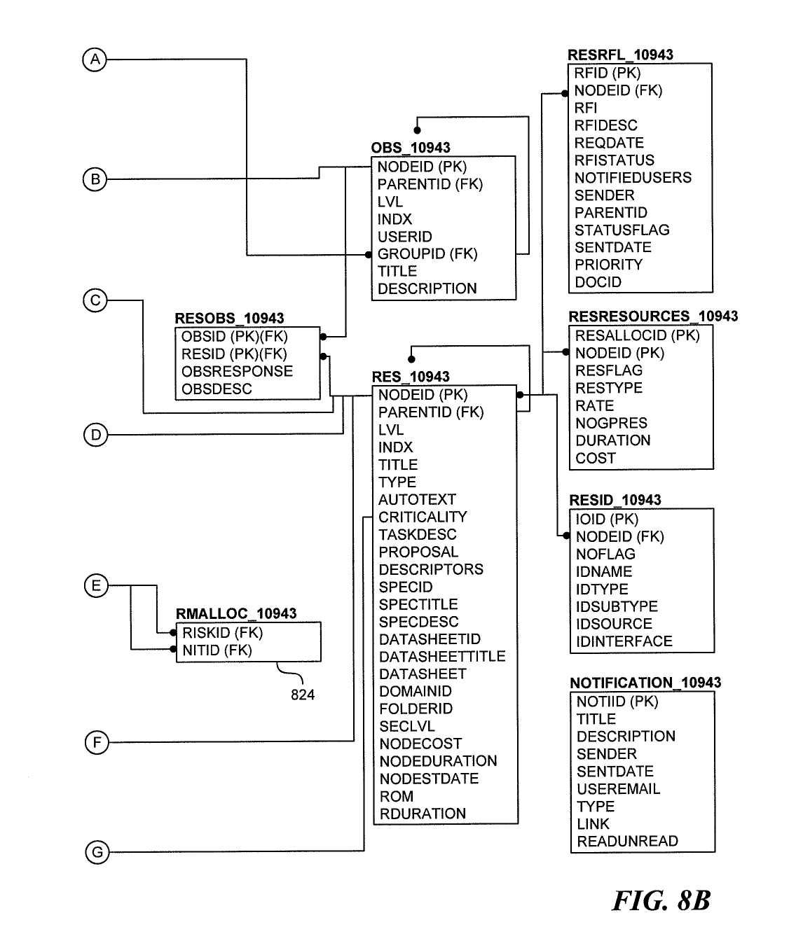

A node of tree 908 can be expanded or retracted by selecting boxes 910 alongside corresponding nodes. Used herein, the meaning of “select” or “left click” includes pressing the left button of the mouse button when the cursor is pointing to the required item. By right clicking a node, the manager brings up a menu that allows the manager to edit the title of the node, delete the node, and save the node to one of databases 210. Used herein, the meaning of “right click” includes pressing the right button of the mouse when the cursor is pointing to the required item. In response, server computer 206 updates a record 802 (FIG. 8) in one or more databases 210.

A frame 912 (FIG. 9) includes a button 914 to add a user and a table 915 listing users assigned to the project (e.g., a “project user list”). Table 915 includes a column 916 for displaying the user names and a column 918 for displaying the users' security level. By selecting a node of tree 908 and then right clicking a row containing a user and his or her security level, the manager can add the user as a sister node or a child node to the selected node via a menu. In response, server computer 206 updates records 804, 806, and 808 (FIG. 8) in one or more databases 210. By selecting a cell containing a user's security level, the manager can set the security level of the user via, e.g., a drop-down list. In response, server computer 206 updates the security level of the user in record 804 in one or more databases 210.

A frame 940 (FIG. 9) includes a button 942 to add a user group and a table 943 listing user groups assigned to the project (e.g., “project group list”). A group is, e.g., a collection of users that often work together. Table 943 includes a column 944 for displaying the group names and a column 946 for displaying the groups' security level. By selecting a node of tree 908 and then right clicking a row containing a group and its security level, the manager can add the group as a sister node or a child node to the selected node via a menu. In response, server computer 206 updates record 808 in one or more databases 210. By selecting a cell containing a group's security level, the manager can set the security level of the group via, e.g., a drop down list. In response, server computer 206 updates a record in one or more databases 210.

If the manager selects button 914 (FIG. 9), server computer 206 generates and transmits one or more web page to client computer 202I. On these web pages, the manager can remove and add users from the project user list. In response, server computer 206 updates record 804 and sends a conventional email to notify the added user that he or she has been assigned to the project. The manager can also invite another user not on the corporate list to work on the project by providing the user's email. In response, server computer 206 updates record 804 and sends a conventional email to notify the user that he or she has assigned to the project.

If the manager selects button 942 (FIG. 9), server computer 206 generates and transmits one or more web pages to client computer 202I. On these web pages, the manager can add and remove groups to the project. The manager can also edit the description and add/remove members to the groups assigned to the project. In response, server computer 206 updates record 806. Table 2 provides the file names of software on client computer 202I (e.g., ASP pages and ActiveX controls) and server computer 206 (e.g., classes of COM components) that performs the above actions.

TABLE 2

| Client computer | Server computer |
|---|---|
| OBStoadduser.asp | OBS.cls |
| OBS.ctl | |

In state 308 (FIG. 3), members 201 create the hierarchical tree of requirements 402 using a tool 240 named “Hierarchical List”. Typically, members with higher authority create requirements at higher levels and assign members with lesser authority to create requirements at lower levels that branch out from the requirements at higher level. For example, a manager creates high-level requirements (e.g., parent elements) and assigns a senior engineer to create mid-level requirements (e.g., child element) that branch from the high-level requirements. The senior engineer then creates mid-level requirements and assigns a junior engineer to create and develop low-level requirements (e.g., grandchild element) that branch from the mid-level requirements. Assignment to requirements is described later in reference to a tool 226 named “Allocation”. Once the hierarchical structure is created, members 201 provide detailed information 408 to each of requirements 402 in states 310, 312, 314, 316, 318, and 322.

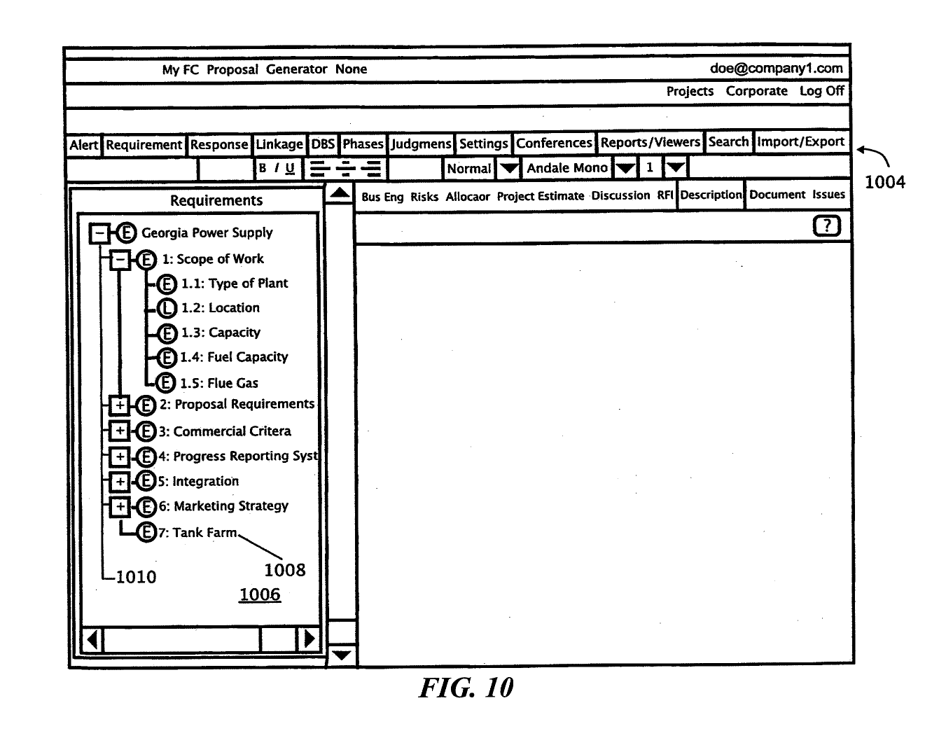

Server computer 206 generates and transmits a web page 1004 (FIG. 10) to client computer 202I. A frame 1006 includes a hierarchical tree 1008 where the nodes represent requirements 402 of the project. A selected node can be indicated by highlight or other graphic representations. A node of tree 1008 can be expanded or retracted by selecting boxes 1010 alongside corresponding parent nodes. By right clicking the node, the manager can add a sister, child, or derived node, delete the node, edit the title of the node, cut the node, copy the node, and paste the node via a menu. In response, server computer 206 creates and/or updates one or more records 802 in one or more databases 210. Tree 1008 includes graphic symbols alongside each node to display the user's access rights to the node according to his or her security level. The graphic symbols include: (1) “E” for the right to view and edit the node, (2) “V” for the right to view but not edit the node, and (3) “L” for no access to the node. If a user has no access to a node, the graphic symbol “L” is displayed alongside a node number indicating the hierarchy of the node. Table 3 provides the file names of software on client computer 202I (e.g., ASP pages and ActiveX controls) and server computer 206 (e.g., classes of COM components) that performs the above actions.

TABLE 3

| Client computer | Server computer |
|---|---|
| Orchtree-ctl | OrchTree.cls |

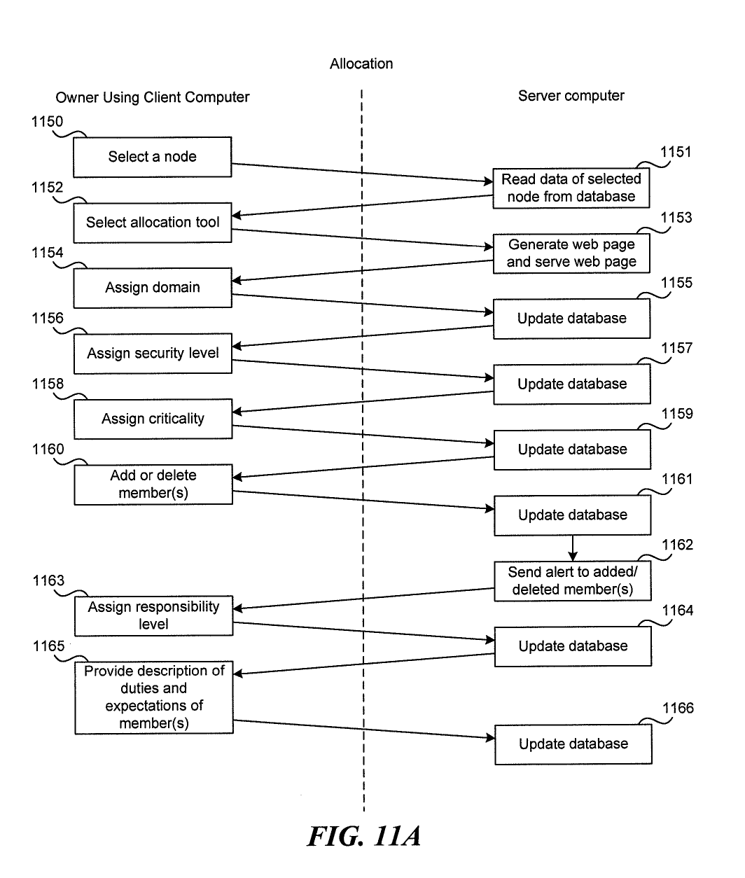

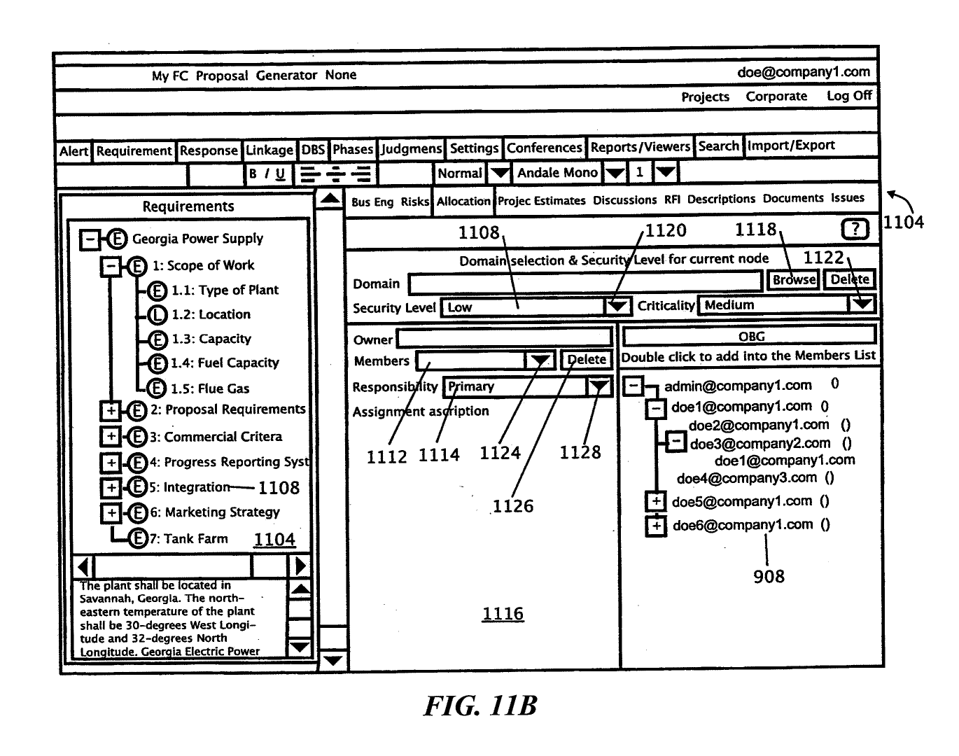

In state 310 (FIG. 3A), a user assigns the responsibility to create and develop one or more requirements 402 to another user using tool 226 named “Allocation”. As described above, members with higher authority typically creates high-level requirements and assigns members with lower authority to create and develop mid- and low-level requirements. State 310 is further described in reference to FIG. 11A.

In action 1150, the user selects a node from requirement tree 1008. In action 1151, server computer 206 reads data (e.g., detailed information 408) of the currently selected node from one or more databases 210 in preparation to respond to the user. In action 1152, the user selects to use tool 226 by, e.g., selecting a button 1102 (FIG. 22). In action 1153, server computer 206 generates and transmits a web page 1104 (FIG. 11B) to client computer 202I. Web page 1104 includes requirement tree 1008 indicating the selected node, OSB tree 908, and data previously provided for the selected node, if any. Theses data includes a domain name in a field 1106, a security level in a field 1108, a criticality level in a field 1110, a list of the member assigned to the node in a field 1112, responsibility levels of the members in a field 1114, a description of the assignment in a field 1116. Domain is, e.g., the specialty area or subject matter within the project that best defines the node.

In action 1154, the user assigns a domain to the selected node. For example, the user (1) selects a button 1118 to bring up a menu that includes a domain list and (2) selects a domain from the list. In action 1155, server computer 206 updates record 802 in one or more databases 210. In action 1156, the user assigns a security level to the selected node via, e.g., a drop-down list 1120. In action 1157, server computer 206 updates record 802 in one or more databases 210. In action 1158, the user assigns a criticality level to the selected node via, e.g., a drop-down list 1122. In action 1159, server computer 206 updates record 802 in one or more databases 210.

In action 1160, the user adds or deletes another user from the selected node. For example, the user double clicks another user in the OSB tree 908 to add that user to the selected node. Used herein, the meaning of “double click” includes pressing the left mouse button twice when the cursor is pointing to the required item. To delete another member from the node, the user selects the member via a drop-down list 1124 and then selecting a delete button 1126. In action 1161, server computer 206 updates record 804 in one or more databases 210. In action 1162, server computer 206 sends an alert to the added or deleted member. For example, one of COM components 510 sends a conventional email to the added or deleted member via SMTP server 524.

In action 1163, the user assigns a responsibility level (e.g., primary, secondary, and review) to a member. For example, the user selects the member via drop-down list 1124 and then selects a responsibility level via a drop-down list 1128. In action 1164, server computer 206 updates record 810 in one or more databases 210.

In action 1165, the user provides a description of the duties and expectations of the assigned member in respect to the selected node. For example, the user enters the description in a field 1116. In action 1166, server computer 206 updates record 810 in one or more databases 210. Based on security levels assigned to members 201, the nodes, and the assignment of members 201 to the nodes, the following access levels are possible:

1. If a user has a security level less than that assigned to the node, and neither has the executive account nor has been assigned to the selected node, then the node is locked to him/her as described above.

2. If a user has a security level equal to that assigned to the node, and he/she neither has the corporate/executive account nor has been assigned to the selected node, then the node can be viewed but not edited by the user as described above.

3. If a user a has security level higher than that assigned to the node, or has an executive account, or has security level less than or equal to that for the node but has been assigned with primary or secondary responsibility for that node, then the node can be edited by the user as described above. Table 4 provides the file names of software on client computer 202I (e.g., ASP pages and ActiveX controls) and server computer 206 (e.g., classes of COM components) that performs the above actions.

TABLE 4

| Action | Client computer | Server computer |
|---|---|---|
| 1150 | 0rchtree.ctl | |
| 1151 | | OrchTree.cls |
| 1152 | N/A | |
| 1153 | | N/A |
| 1154 | SysAlloc.ct1 | |
| 1155 | | SysAlloc.cls |
| 1156 | SysAlloc.ctl | |
| 1157 | | SysAlloc.cls |
| 1158 | SysAlloc.ctl | |
| 1159 | | SysAlloc.cls |
| 1160 | SysAlloc.ctl | |
| 1161 | | SysAlloc.cls |
| 1162 | | Notification.cls |
| 1163 | SysAlloc.ctl | |
| 1164 | | SysAlloc.cls |
| 1165 | SysAlloc.ctl | |
| 1166 | | SysAlloc.cls |

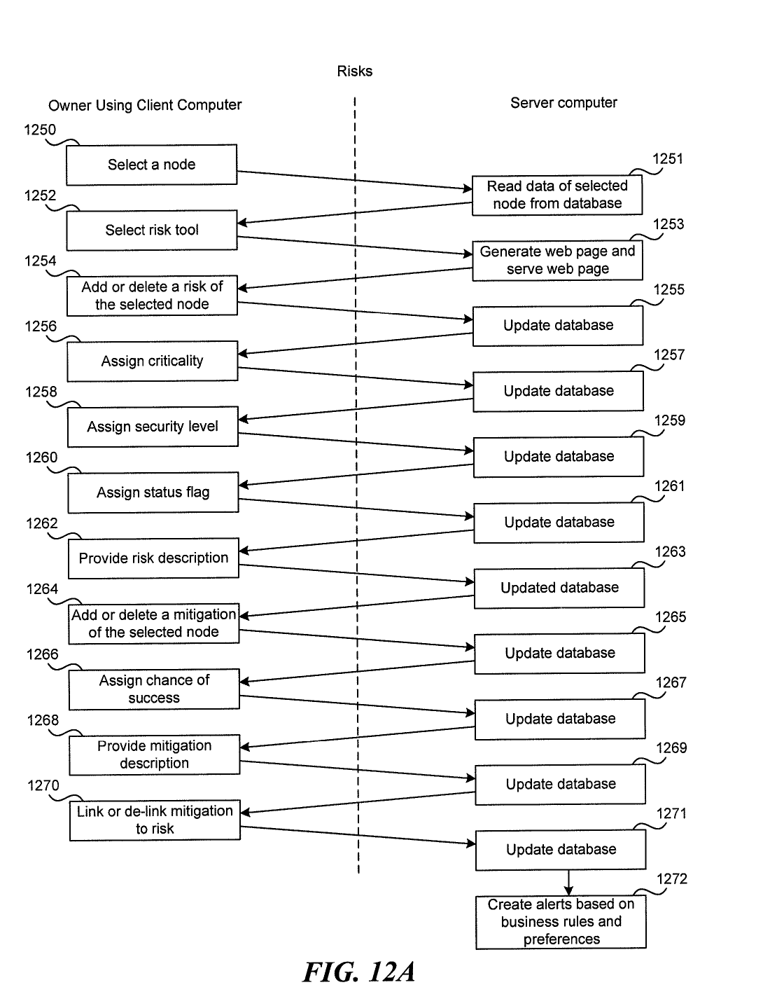

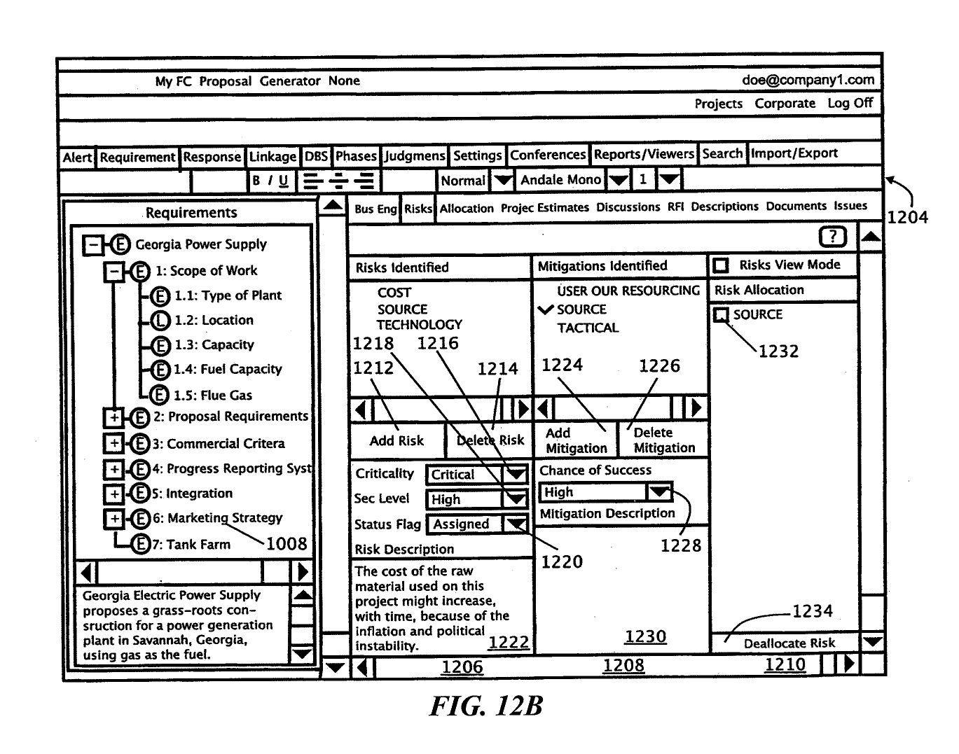

In state 312 (FIG. 3), members 201 identify, review, and mitigate risks of one or more requirements 402 using a tool 224 called “Risks”. In action 1250 (FIG. 12A), a user selects a node from requirement tree 1008. In action 1251, server computer 206 reads data (e.g., detailed information 408) of the currently selected node from one or more databases 210. In action 1252, the user selects a button 1202 (FIG. 22) to use tool 224. In action 1253, server computer 206 generates and transmits a web page 1204 (FIG. 12B) to client computer 202I. Web page 1204 includes (1) requirement tree 1008 indicating the selected node, (2) a frame 1206 including identified risks to the selected node, if any, (3) a frame 1208 including identified mitigations to the identified risks, if any, (4) and a frame 1210 including mitigations linked to a selected risk, if any.

In action 1254, the user can add a risk to the selected node. For example, the user selects a button 1212 to bring up a menu and then selects a risk from a predetermined list and/or creates a new type of risk. The user can also delete a risk. For example, the user selects a risk in frame 1206 and then selects a delete button 1214. In action 1255, server computer 206 updates record 812 in one or more databases 210. In action 1256, the user assigns a criticality level (e.g., critical, high, medium, and low) to a selected risk via a drop-down list 1216. In action 1257, server computer 206 updates record 812 in one or more databases 210. In one implementation, if a risk is flagged as being highly critical but has not been assigned to anyone or has been assigned but has not been mitigated, work engine 522 will trigger an automatic alert to the users responsible for that node.

In action 1258, the user assigns a security level (e.g., 1 through 4) to the selected node via a drop-down list 1218. In action 1259, server computer 206 updates record 812 in one or more databases 210. In action 1260, the user assigns a status flag (e.g., assigned, mitigated, challenged, and deleted) to a selected risk via a drop-down list 1220. In action 1261, server computer 206 updates record 812 in one or more databases 210. In action 1262, the user provides a description of a selected. For example, the user enters the description in a field 1222. In action 1263, server computer 206 updates record 812 in one or more databases 210.

In action 1264, the user can add mitigation to the selected node by selecting a button 1224 to bring up a menu. The user selects mitigations from a predetermined list and creates new types of mitigation in the menu in the menu. The user can also delete mitigation to the selected node. For example, the user selects the mitigation and then selects a delete button 1226. In action 1265, server computer 206 updates record 812 in one or more databases 210. In action 1266, the user assigns a chance of success (e.g., critical, high, medium, and low) to a selected risk via a drop-down list 1228. In action 1267, server computer 206 updates record 812 in one or more databases 210.

In action 1268, the user provides a description of the risk. For example, the user enters the description in a field 1230. In action 1269, server computer 206 updates record 812 in one or more databases 210. In action 1270, the user can link mitigation to a risk. For example, the user selects a risk, right clicks a mitigation to bring up a menu, and then selects an allocation button in the menu. The user can also de-link mitigation to a risk. For example, the user selects a risk, selects boxes 1232 alongside corresponding mitigations linked to the selected risk in frame 1210, and then selects a button 1234. In action 1271, server computer 206 updates records 708 (FIG. 7) and 824 (FIG. 8) in one or more databases 210. In action 1272, server computer 206 creates alerts based on the workflow selected for the project. For example, workflow engine 522 sends out alerts to the appropriate recipients. Table 5 provides the file names of software on client computer 202I (e.g., ASP pages and ActiveX controls) and server computer 206 (e.g., classes of COM components) that performs the above actions.

TABLE 5

| Action | Client computer | Server computer |
|---|---|---|
| 1250 | Orchtree.ct1 | |
| 1251 | | OrchTree.cls |
| 1252 | N/A | |
| 1253 | | N/A |
| 1254 | RiskMgmt.ctl | |
| 1255 | | RiskMgmt.cls |
| 1256 | RiskMgmt.ctl | |
| 1257 | | RiskMgmt.cls |
| 1258 | RiskMgmt.ctl | |
| 1259 | | RiskMgmt.cls |
| 1250 | RiskMgmt.ctl | |
| 1261 | | RiskMgmt.cls |
| 1262 | RiskMgmt.ctl | |
| 1263 | | RiskMgmt.cls |
| 1264 | RiskMgmt.ctl | |
| 1265 | | RiskMgmt.cls |
| 1266 | RiskMgmt.ctl | |
| 1267 | | RiskMgmt.cls |
| 1268 | RiskMgmt.ctl | |
| 1269 | | RiskMgmt.cls |
| 1270 | RiskMgmt.ctl | |
| 1271 | | RiskMgmt.cls |
| 1272 | | Notification.cls |

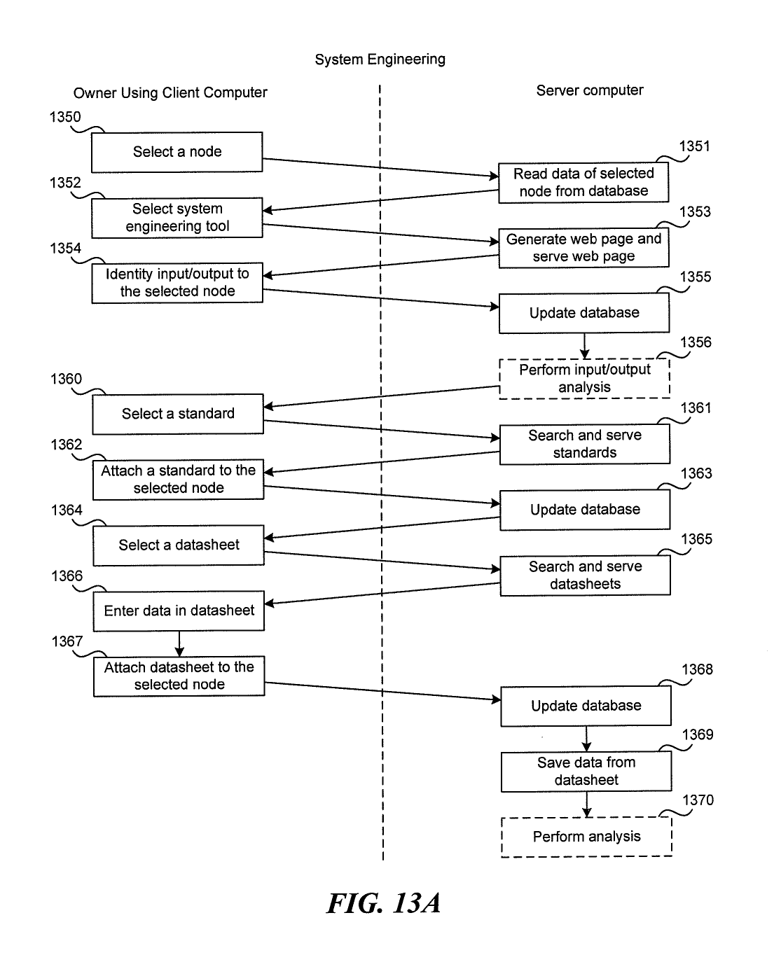

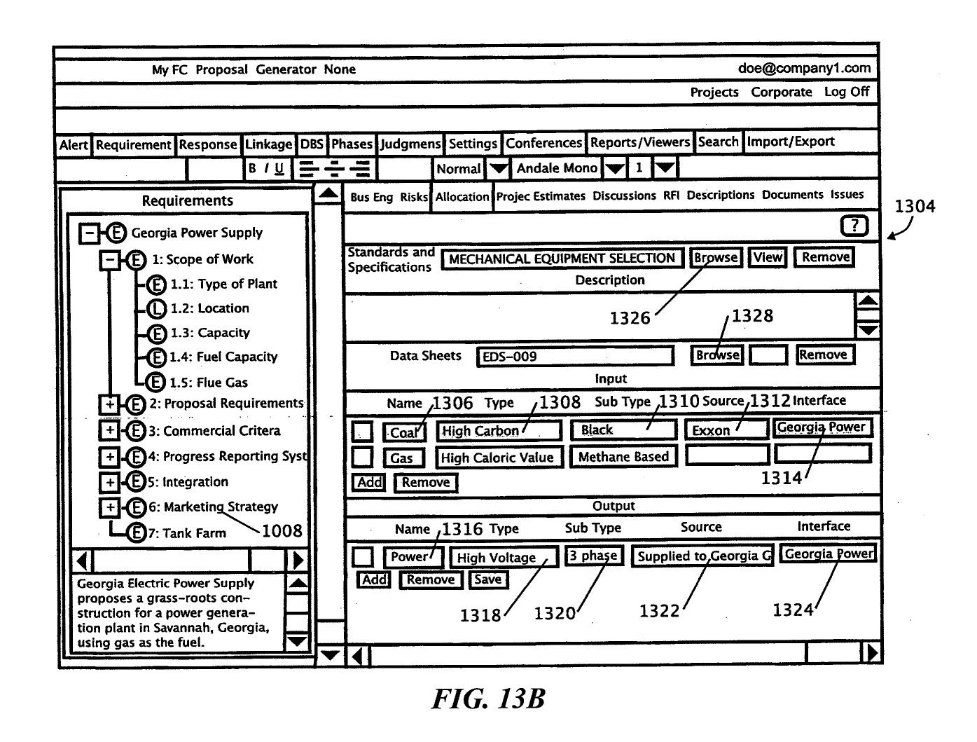

In state 316 (FIG. 3), members 201 develop specifications of one or more requirements 402 using a tool 222 called “System Engineering”. In action 1350 (FIG. 13A), the user selects a node from requirement tree 1008. In action 1351, server computer 206 reads data (e.g., detailed information 408) of the currently selected node from one or more databases 210. In action 1352, the user selects a button 1302 (FIG. 22) to use tool 228. In action 1353, server computer 206 generates and transmits a web page 1304 (FIG. 13B) to client computer 202I. Web page 1304 includes tree 1008 indicating the selected node and one or more frames where the user can provide system engineering information.

In action 1354, the user identifies one or more inputs and outputs to the selected node. For example, the user enters the input name in a field 1306, the input type in a field 1308, the input subtype in a field 1310, the input source in a field 1312, and the input interface in a field 1314. An exemplary technical input is defined by an input name of “fuel”, a type of “gasoline”, a source of “fuel pump”, and an interface of “connector D 19”. An exemplary legal input is defined by an input name of “applicant”, type of “client”, subtype of “inventor”, source of “node 1.0 in tree 1008”, and an interface of “conference meetings”. The user can also enter the output name in a field 1316, the output type in a field 1318, the output subtype in a field 1320, the output destination in a field 1322, and the output interface in a field 1324. An exemplary technical output is defined by an output name of “torque”, a type of “mechanical”, a destination of “transmission”, and an interface of “a coupling according to specification X from Y”.

In action 1355, server computer 206 updates record 814 in one or more databases 210. In action 1356, server computer 206 optionally performs input/output analysis on the input. For example, server computer 206 can print out a network of all inputs and outputs identifying hanging outputs and unfilled inputs.

In action 1360, the user accesses standards and specifications relevant to the selected node. The user selects a browse button 1326 to view a list of standards and specifications stored in one or more databases 210. Standards includes a specification that is either widely used and accepted (de facto) or is sanctioned by a standards organization (de jure) such as American Society of Mechanical Engineers and Institute of Electrical and Electronics Engineers. As previously mentioned, specifications encompass both technical and commercial specification, the latter of which includes contracts, laws, business rules and directives. In action 1361, server computer 206 searches one or more databases 210 to create the list of standards and specifications. In action 1362, the user selects a standard or a specification from the list to be attached to the selected to the selected node. In action 1363, server computer 206 updates record 802 to include the selected standard or specification in one or more databases 210.

In action 1364, the user accesses datasheets of an item relevant to the selected node. The user selects a browse button 1328 to view a list of datasheets stored in one or more databases 210. In action 1365, server computer 206 searches one or more databases 210 to create the list of datasheets. In action 1366, the user selects a datasheet and enters data in the datasheet. For example, the data entered into the datasheet includes engineering parameters as specified in the datasheet, contractual terms and conditions in a standard legal form, and labor specifications in a job application or a resume. In action 1367, the user submits the datasheet to server computer 206 to be attached to the selected node. In action 1368, server computer 206 updates record 802 to include the selected datasheet in one or more databases 210. In action 1369, server computer updates record 802 to include the data contained in the selected datasheet in one or more databases. In action 1370, server computer 206 optionally performs an additional analysis. For example, server computer 206 can query and sum the electric current drawn by at 440 volts by all pumps specified in the datasheets of one or more nodes.

Please note that the analyses described above can also be done by another computer, operated by the owner or the bidder, that has access to one or more databases 210. Table 6 provides the file names of software on client computer 202I (e.g., ASP pages and ActiveX controls) and server computer 206 (e.g., classes of COM components) that performs the above actions.

TABLE 6

| Action | Client computer | Server computer |
|---|---|---|
| 1350 | Orchtree.ct1 | |
| 1351 | | OrchTree.cls |
| 1352 | N/A | |
| 1353 | | N/A |
| 1354 | Sysengg.asp | |
| 1355 | | SysEngg.cls |
| 1356 | | Optional |
| 1360 | DomainList.ctl | |
| 1361 | | SysEngg.cls |
| 1362 | DomainList.ctl | |
| 1363 | | SysEngg.cls |
| 1364 | DomainList.ctl | |
| 1365 | | SysEngg.cls |
| 1366 | DomainList.ctl | |
| 1367 | DomainList.ctl | |
| 1368 | | SysEngg.cls |
| 1369 | | SysEngg.cls |
| 1370 | | Optional |

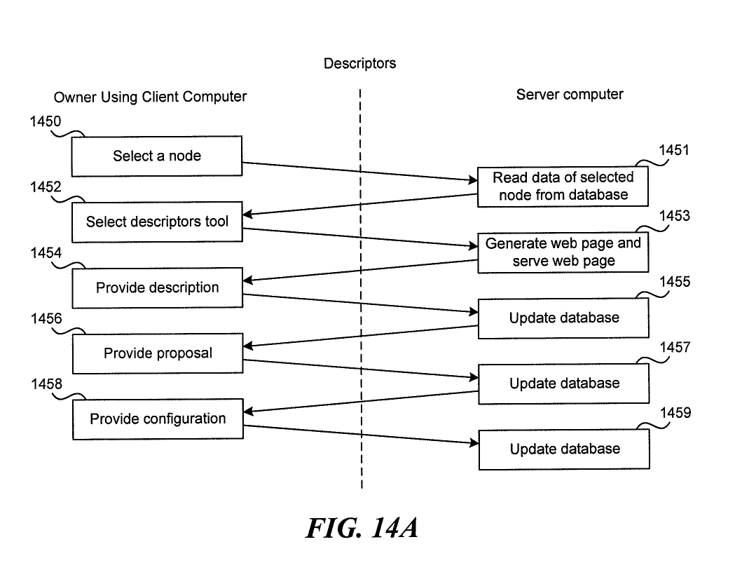

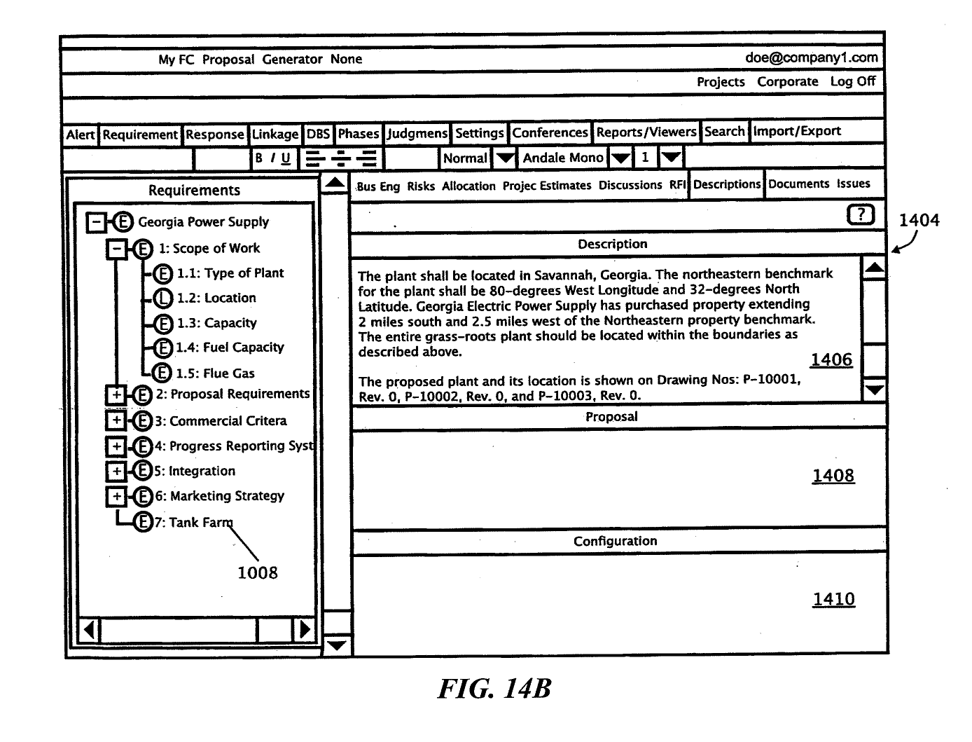

In state 316 (FIG. 3), members 201 can also develop descriptions for one or more requirements using a tool 234 called “Descriptors”. In action 1450 (FIG. 14A), the user selects a node from requirement tree 1008. In action 1451, server computer 206 reads data (e.g., detailed information 408) of the currently selected node from one or more databases 210. In action 1452, the user selects a button 1402 (FIG. 22) to use tool 234. In action 1453, server computer 206 generates and transmits a web page 1404 (FIG. 14B) to client computer 202I.

In action 1454, the user provides a general description of the selected node. For example, the user enters the description in a field 1406. In one implementation, the user can launch a word processor (e.g., Microsoft Word) by selecting a button in web page 1404 and then write the description in word processor. When the user exits the word processor, client computer 202I automatically imports the written description into field 1406. In action 1455, server computer 206 updates record 802 in one or more databases 210. In action 1456, the user provides a formal description of the selected node. For example, the user enters the formal description in a field 1408. Formal description is the formal language to be used in a proposal of the selected node. In action 1457, server computer 206 updates record 802 in one or more databases 210. In action 1458, the user provides a technical description of the selected node. For example, the user enters the technical description in a field 1410. Technical description is the technical information specific to the engineering requirement of the selected node. In action 1459, web server 206 updates record 802 in one or more databases 210. Table 7 provides the file names of software on client computer 202I (e.g., ASP pages and ActiveX controls) and server computer 206 (e.g., classes of COM components) that performs the above actions.

TABLE 7

| Action | Client computer | Server computer |
|---|---|---|
| 1450 | Orchtree.ct1 | |
| 1451 | | OrchTree.cls |
| 1452 | N/A | |
| 1453 | | N/A |
| 1454 | Descriptors.ctl | |
| 1455 | | Descriptors.cls |
| 1456 | Descriptors.ctl | |
| 1457 | | Descriptors.cls |
| 1458 | Descriptors.ctl | |
| 1459 | | Descriptors.cls |

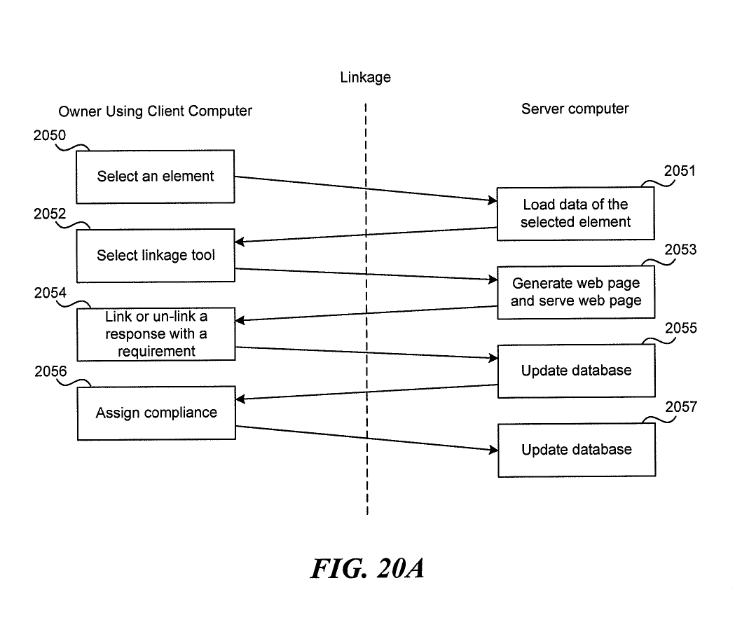

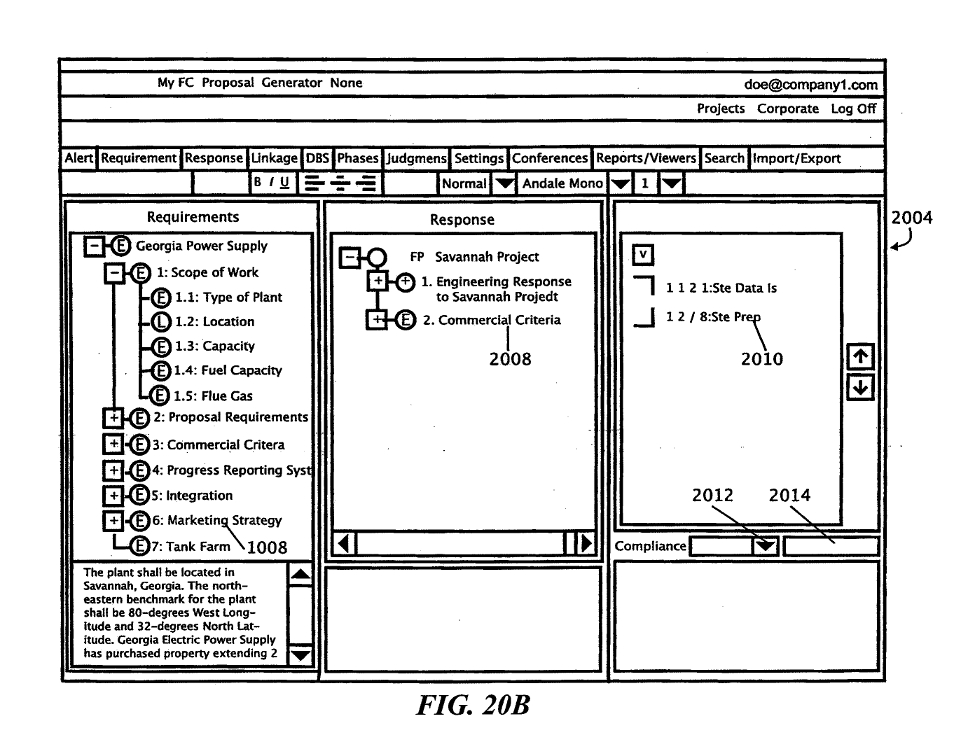

In state 317 (FIG. 3), members 201 can link one or more of responses 404 to one or more of requirements 402 after members 203 create requirements 402. This state is described later in reference to FIGS. 20A and 20B.

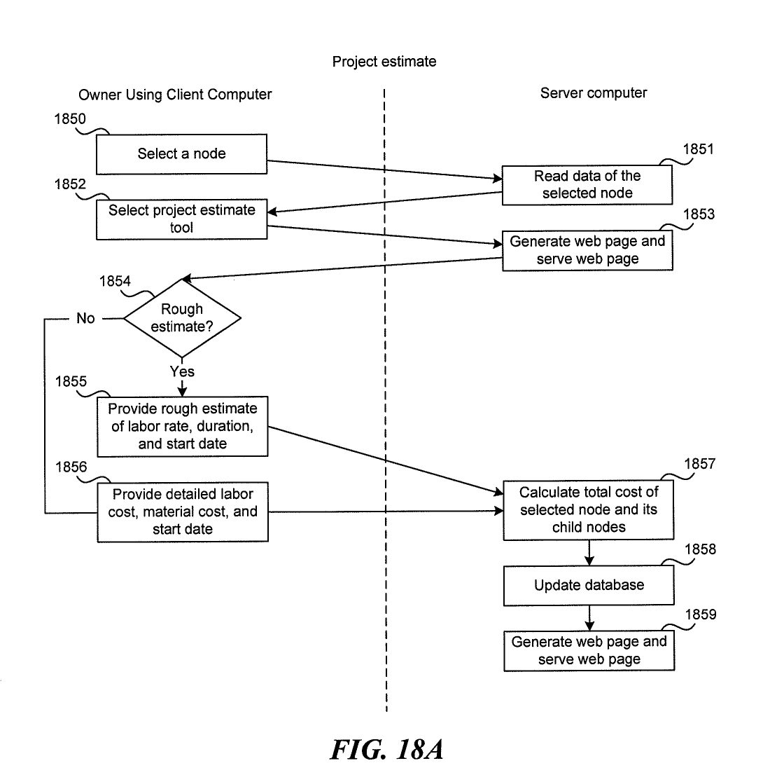

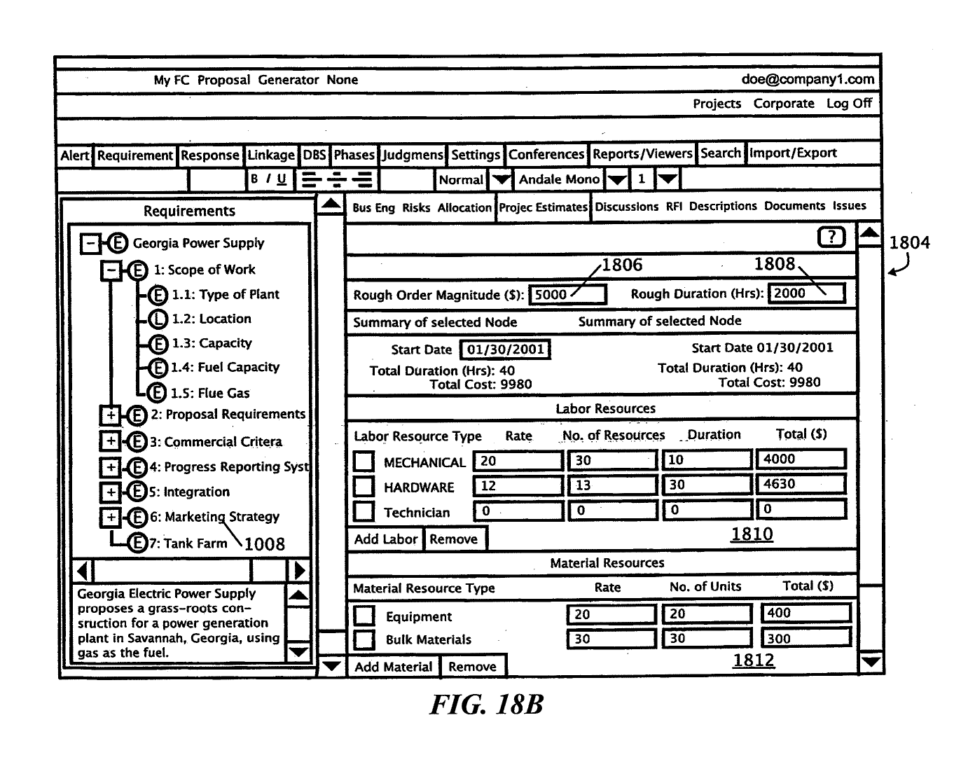

In state 314, members 201 can calculate the estimated costs of a project using a tool 228 called “Project Estimate”. In action 1850 (FIG. 18A), the user selects a node from requirement tree 1008. In action 1851, server computer 206 reads data of the selected node from one or more databases 210. In action 1852, the user selects tool 228 to calculate estimated costs of the selected node. For example, the user selects a button 1802 (FIG. 22). In action 1853, server computer 206 generates and transmits a web page 1804 (FIG. 18B) to client computer 202I for calculating the estimated costs. Web page 1804 includes tree 1008 indicating the selected node and one or more frames where the user can provide estimated cost information. In action 1854, the user decides whether to use a rough estimate instead of a detailed estimate. If the user decides to use a rough estimate, action 1854 is followed by action 1855. Otherwise action 1854 is followed by action 1856.

In action 1855, the user provides a rough estimate of the labor rate ($/hr) and duration (hr). For example, the user enters the rough estimates of the labor rate and duration in fields 1806 and 1808, respectively. In action 1856, the user provides a detailed estimate by accounting for (1) each labor resource type its rate, number of resources, and duration, and (2) each material resource type its cost and number of units. For example, the user enters the accurate estimates of the labor and material in frames 1810 and 1812, respectively. Both actions 1855 and 1856 are followed by action 1857.

In action 1857, server computer 206 calculates the total cost of the selected node and its child nodes. In action 1858, server computer 206 updates a record 820 in one or more database 210 with the estimates. In action 1859, server computer 206 regenerates web page 1804 with the calculated total estimate of the selected node and its child node and sends web page 1804 to client computer 202I. Table 8 provides the file names of software on client computer 202I (e.g., ASP pages and ActiveX controls) and server computer 206 (e.g., classes of COM components) that performs the above actions.

TABLE 8

| Action | Client computer | Server computer |
|---|---|---|
| 1850 | Orchtree.ct1 | |
| 1851 | | OrchTree.cls |
| 1852 | N/A | |
| 1853 | | N/A |
| 1854 | ProjectEstimate.asp | |
| 1855 | ProjectEstimate.asp | |
| 1856 | ProjectEstimate.asp | |
| 1857 | | ProjectEstimate.cls |
| 1858 | | ProjectEstimate.cls |
| 1859 | | ProjectEstimate.cls |

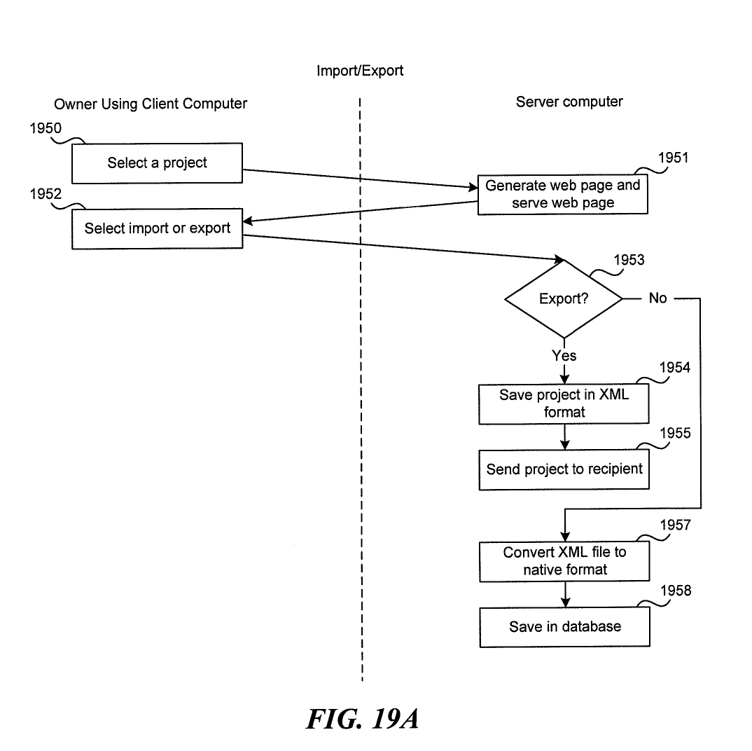

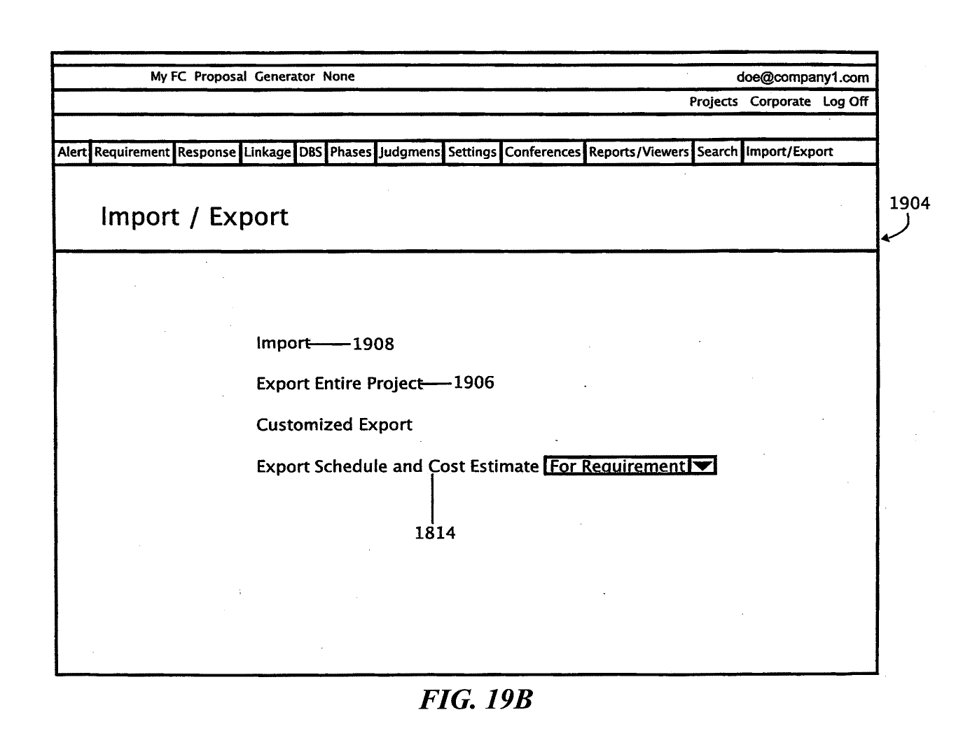

State 314 can be followed by state 315. In state 315, the user exports a project plan including one or more requirements, one or more responses, their node numbers, descriptions, start dates, end dates, material and labor resource allocations, and estimated costs, to a conventional project management software including Microsoft Project and Primavera Project Planner. For example, the user selects an export button 1814 (FIG. 19B) on a web page 1904 (described later in reference to FIG. 19B) to cause server computer 206 to retrieve the appropriate data of a selected node from one or more databases 210 and save the data in a format accepted by the conventional project management software. Similarly, the user can import the estimated costs of the project from the conventional project management software. For example, the user causes server computer 206 to load a file saved in a format accepted by the conventional project management software, to retrieve the data from the file, and update record 820 in one or more databases 210 with the retrieved data. Table 9 provides the file names of software on client computer 202I (e.g., ASP pages and ActiveX controls) and server computer 206 (e.g., classes of COM components) that performs the above actions.

TABLE 9

| Client computer | Server computer |
|---|---|
| XMLBKExportPro.asp | OrchestraUtil.cls |

In the process of developing the details of requirements 402 in states 310, 312, 314, and 316, members may identify new requirements that need to be created or existing requirements that need to be elaborated. If so, states 310, 312, 314, and 316 are followed by state 308. Here, the user may identify the new requirements as “derived nodes”. In the process of developing the details of requirements 402 in states 310, 312, 314, and 316, members 201 may need to consult with each other. If so, states 310, 312, 314, and 316 are followed by state 318.

In state 318 (FIG. 3), members 201 can hold an online conference using a tool 246 called “Conference”. Members 201 can also view the contents of a past conference in context using a tool 230 called “Discussion”.

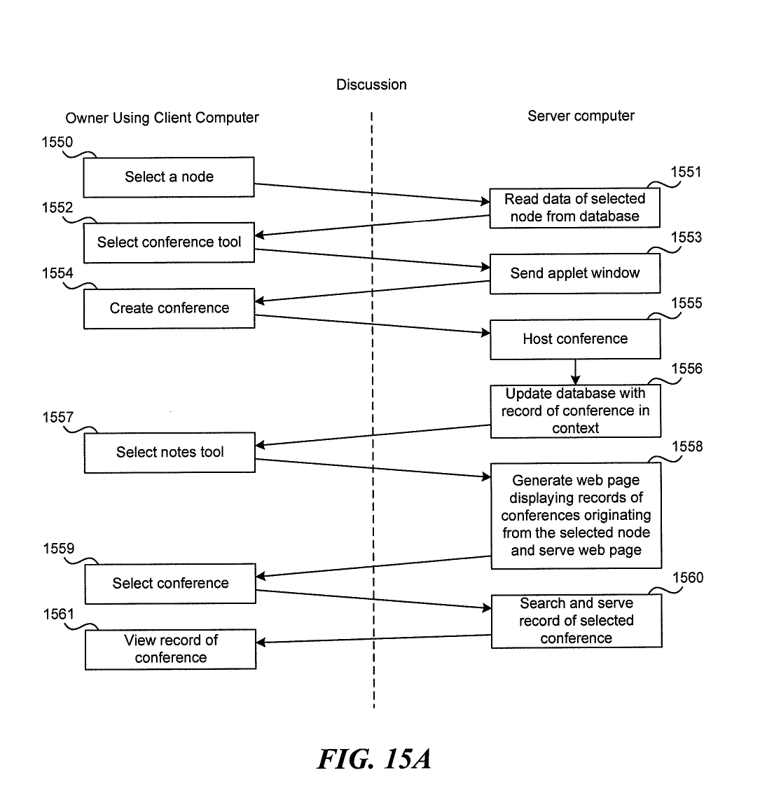

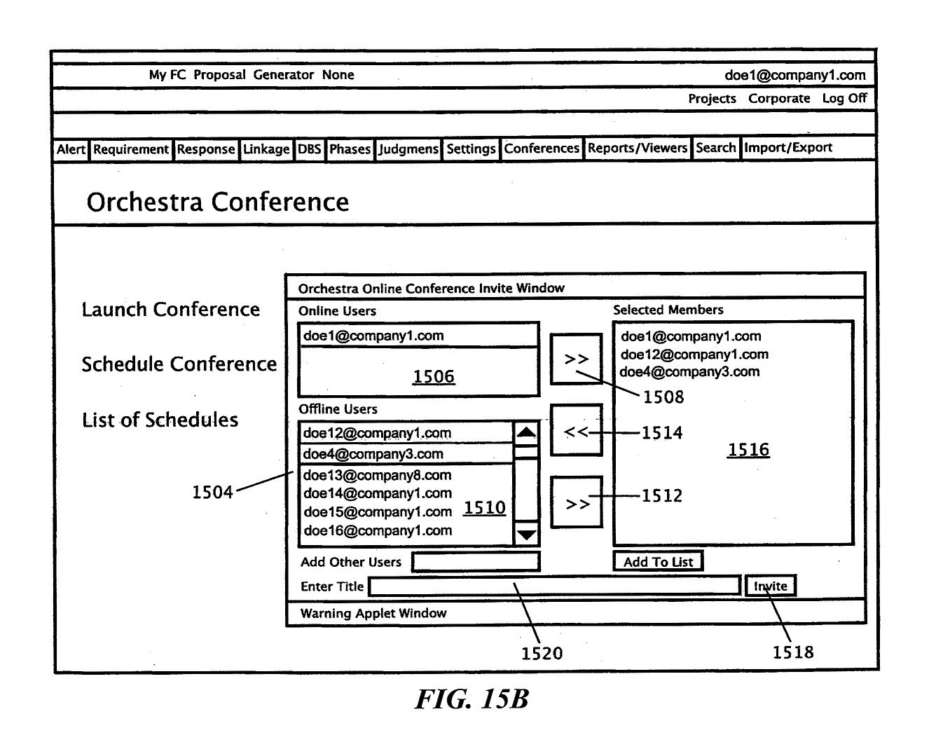

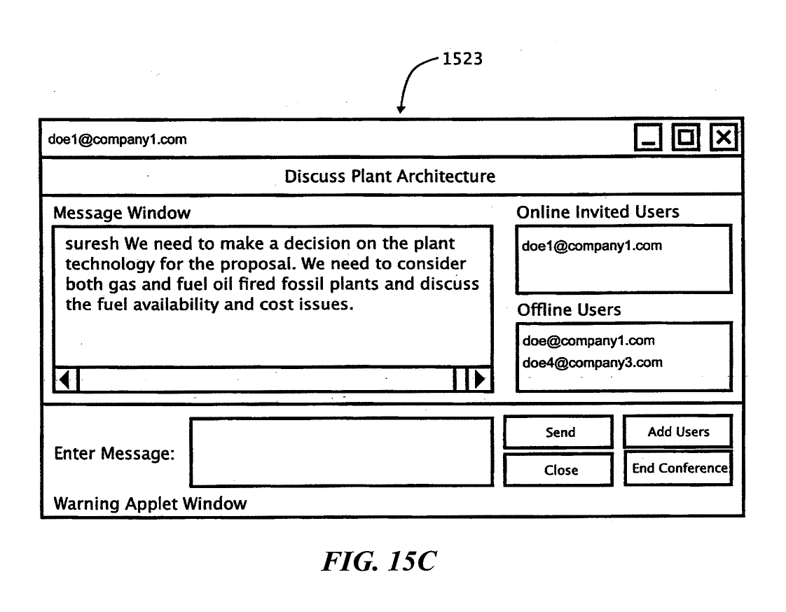

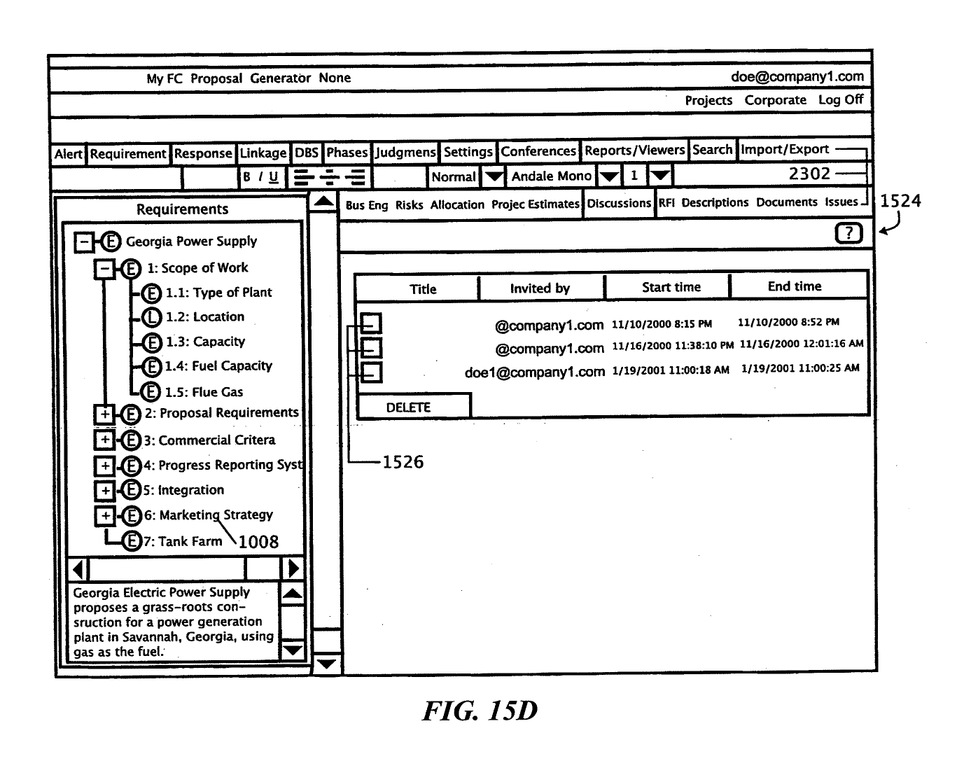

In action 1550 (FIG. 15A), the user selects a node from requirement tree 1008. In action 1551, server computer 206 reads data (e.g., detailed information 408) of the currently selected node from one or more databases 210. In action 1552, the user selects a button 1502 (FIG. 22) to use tool 246. In action 1553, server computer 206 transmits a conventional applet that creates an applet window 1504 (FIG. 15B) to client computer 202I.

In action 1554, the user creates a conference by inviting users to join the conference. The user add others to a list of invitees by selecting from a list of online users in a frame 1506 and then selecting a button 1508, and selecting from a list of offline users in a frame 1510 and then selecting a button 1512. The user can remove others from the invitee list by selecting them and then selecting a remove button 1514. The invitees are listed in a frame 1516. Once the user has gathered all his invitees, the user selects a button 1518 to start the online conference. The user can enter a title for the conference in a field 1520. In action 1555, server computer 206 transmits an applet that creates an applet window 1523 to client computer 202I for the online conference. Server computer hosts the online conference using, e.g., a conventional chat server 528 (FIG. 5). Please note actions 1553, 1554, and 155 can be provided by a third party provider of online conferences such as Yahoo, WebEx and NetMeeting.

In action 1556, server computer 206 updates a record 816 in one or more databases 210 to save the content of the online conference. In action 1557, the user selects a button 1522 (FIG. 22) to use tool 230 to view the content of an online conference in context. In action 1558, server computer 206 generates and transmits a web page 1524 (FIG. 15D) to client computer 202I. Web page 1524 includes tree 1008 indicating the selected node and a list of the online conferences originating from the selected node. Thus, the user can view all the conferences relevant to the selected node. In addition, the user can view other detailed information for the selected node by selecting other tools of software 212 from menu 2302 (FIGS. 15D and 22).

In action 1559, the user selects one of the online conferences to view the content of the online conference. For example, the user selects the hypertext title of the online conferences. In action 1560, server computer 206 searches one or more of databases 210 to retrieve the content and sends the content to client computer 202I. In action 1561, the user views the content of the selected online conference using client computer 202I. Table 10 provides the file names of software on client computer 202I (e.g., ASP pages and ActiveX controls) and server computer 206 (e.g., classes of COM components) that performs the above actions. Table 10 provides the file names of software on client computer 202I (e.g., ASP pages and ActiveX controls) and server computer 206 (e.g., classes of COM components) that performs the above actions.

TABLE 10

| Action | Client computer | Server computer |
|---|---|---|
| 1550 | Orchtree.ctl | |
| 1551 | | OrchTree.cls |
| 1552 | N/A | |
| 1553 | | N/A |
| 1556 | | Conference.cls |
| 1557 | Notes.asp | |
| 1558 | | Notes.cls |
| 1559 | Notes.asp | |
| 1560 | | Notes.cls |
| 1561 | | Notes.cls |

In state 318 (FIG. 3), members 201 can also send threaded messages 242 within the context of the selected node or element (e.g., emails) to each other using a tool 232 called “Messages”. In action 1650 (FIG. 16A), the user selects a node from requirement tree 1008. In action 1651, server computer 206 reads data (e.g., detailed information 408) of the currently selected node from one or more databases 210. In action 1652, the user selects a button 1602 (FIG. 22) to use tool 232. In action 1653, server computer 206 generates and transmits a web page 1604 (FIG. 16B) to client computer 202I. Web page 1604 includes tree 1008 indicating the selected node and a list 1606 of all the messages originating from the selected node arranged in a thread. Thus, the user can view all the messages relevant to the selected node and their relationship to each other. In addition, the user can view other detailed information for the selected node by selecting other tools of software 212 from menu 2302 (FIGS. 16B and 22).

In action 1654, the user selects a message from the list of messages. In action 1655, server computer 206 generates and transmits a web page that includes the selected message to client computer 202I. In action 1656, the user views the selected message. In action 1657, the user can send a new message to another user. The user can also reply to the selected message by selecting a reply button after viewing the selected message. In action 1658, server computer 206 updates the database record 818 in one or more databases 210 with the node ID of the selected node (e.g., recording the context of the message) and the message ID of the message being responded to, if any (recording the thread of the message). In action 1659, server computer 206 sends notifications to the recipient. In action 1662, server computer sends an alert to the recipient if the recipient has not replied by the respond-by date. For example, workflow engine 522 sends a conventional email to the recipient. Table 11 provides the file names of software on client computer 202I (e.g., ASP pages and ActiveX controls) and server computer 206 (e.g., classes of COM components) that performs the above actions.

TABLE 11

| Action | Client computer | Server computer |
|---|---|---|
| 1650 | Orchtree.ctl | |
| 1651 | | OrchTree.cls |
| 1652 | N/A | |
| 1653 | | N/A |
| 1654 | RFIcal.asp | |
| 1655 | | RFI.cls |
| 1656 | RFIDesc.asp | |
| 1657 | RFIform.asp | |
| 1658 | | RFI.cls |
| 1659 | | Notification.cls |
| 1660 | | Notification.cls |

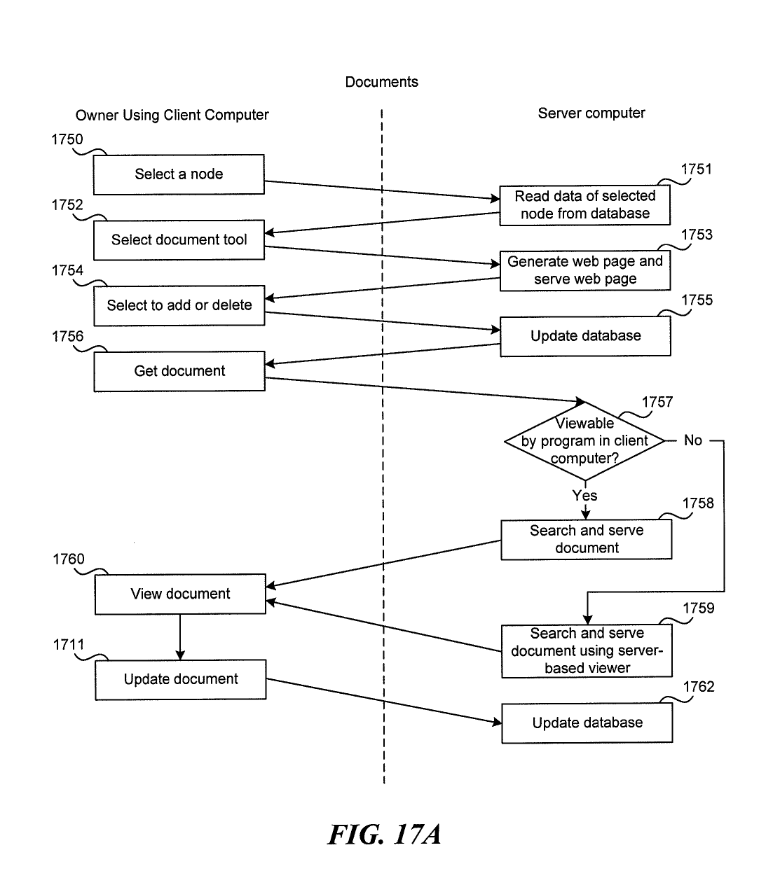

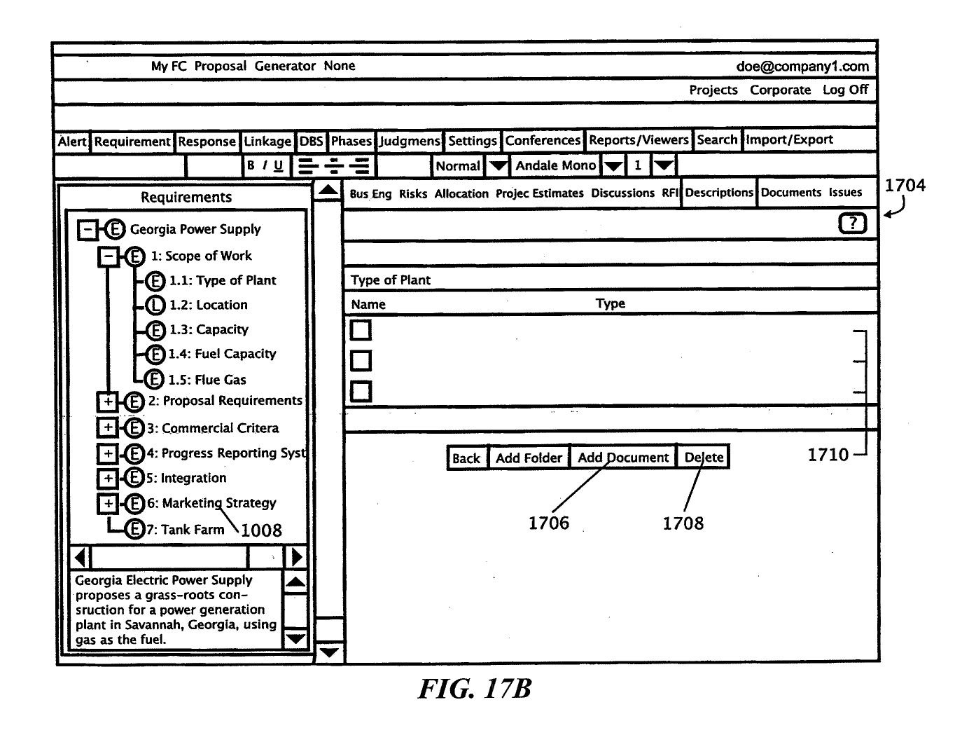

In the process of developing the specification and description in state 316 can be followed by state 322. In state 322 (FIG. 3), members 201 may store, view, and retrieve documents created within software 212, or documents of any kind created in an electronic format in any third party tool, using a tool 236 called “Documents”. In action 1750 (FIG. 17A), the user selects a node from requirement tree 1008. In action 1751, server computer 206 reads data (e.g., detailed information 408) of the currently selected node from one or more databases 210. In action 1752, the user selects a button 1702 (FIG. 22) to use tool 232. In action 1753, server computer 206 generates and transmits a window 1704 (FIG. 17B) to client computer 202I. Window 1704 includes tree 1008 indicating the selected node and a list 1712 of documents attached to the selected node.

In action 1754, the user attaches a document to the selected node. For example, the user selects a button 1706 that brings up a menu. The menu allows the user to select a document in client computer 202I and to attach the document to the selected node. Alternatively, the user deletes a document attached to the node. For example, the user selects a document in list 1712 and then a delete button 1708. In action 1755, server computer 206 updates records 710, 712, and 714 in one or more database 210 to save or delete the selected document. In action 1756, the user gets a document attached to the node. For example, the user selects a document in list 1712, a version number, if any, and then a view button 1710. In action 1757, server computer 206 determines if client computer 202I has the appropriate program to view the selected document. If so, action 1757 is followed by action 1758. Otherwise, action 1757 is followed by action 1759.

In action 1758, server computer searches for the selected document in databases 210 and transmits the selected document to client computer 202I. Action 1758 is followed by action 1760. In action 1759, server computer searches for the selected document, processes the selected document with a server-based viewer, and then transmits the selected document to client computer 202I. The server-based viewer is, e.g., Brava! Server 526. In action 1760, the user views the selected document. In action 1761, the user updates the document. For example, the user selects a first document in list 1712 and then an update button that brings up a menu. The menu allows the user to select a second document on client computer 202I. In action 1762, server computer 206 updates record 710, 712, and 714 in one or more databases 210 to save the second document as an updated version of the first document. Table 12 provides the file names of software on client computer 202I (e.g., ASP pages and ActiveX controls) and server computer 206 (e.g., classes of COM components) that performs the above actions.

TABLE 12

| Action | Client computer | Server computer |
|---|---|---|
| 1750 | Orchtree.ctl | |
| 1751 | | OrchTree.cls |
| 1752 | N/A | |
| 1753 | | N/A |
| 1754 | Adddocument.asp | |
| | Orchdocumentfoldersm.asp | |
| | Orchdocumentfolder.asp | |
| 1755 | | Documents.cls |
| 1756 | Editdocument.asp | |
| 1757 | | Documents.cls |
| 1758 | | Documents.cls |
| 1759 | | Documents.cls |
| 1760 | Viewdocument.asp | |
| 1761 | Adddocument.asp | |
| 1762 | | Documents.cls |

After members 201 have developed sufficient details to requirements 402, state 308 is followed by state 320. In state 320, members 201 review the details of requirements 402 and the document attached to requirements 402. In the process of reviewing the details of requirements 402, members 201 may need to consult each other. If so, state 320 is followed by state 318 where members 201 consults each other using email and online conferences. The members 201 may also need to view the documents. If so, state 320 is followed by state 322.

After members 201 have reviewed and approved the details and documents of requirements 402, state 320 is followed by state 324. In state 324, members 201 export requirements 402 as a request for proposals to potential bidders. In action 1950 (FIG. 19A), the user selects a first project. In action 1951, server computer 206 generates a web page 1904. In action 1952, a user selects to export the first project or import a second project. For example, the user selects a button 1906 to export the first project or a button 1908 to import the second project. In action 1953, server computer 206 determines if the user wants to export or import a project. If the user wants to export a project, action 1953 is followed by action 1954. Otherwise action 1953 is followed by 1957.

In action 1954, server computer 206 saves the first project in XML format. In action 1955, server computer 206 sends the project to the recipient (e.g., the bidder).

In action 1957, server computer 206 converts second project from XML format to the native format of the files contained therein. In action 1958, server computer 206 saves the project in one or more database 210. Table 13 provides the file names of software on client computer 202I (e.g., ASP pages and ActiveX controls) and server computer 206 (e.g., classes of COM components) that performs the above actions.

TABLE 13

| Action | Client computer | Server computer |
|---|---|---|
| 1950 | N/A | |
| 1951 | | N/A |
| 1952 | XMLbk.asp or | |
| | XMLBKExportPro.asp | |
| 1953 | | N/A |
| 1954 | | OrchestraUtil.export.cls |
| 1955 | | OrchestraUtil.export.cls |
| 1957 | | OrchestraUtil.import.cls |
| 1958 | | OrchestraUtil.import.cls |

Action 106 is the same as action 102 except that (1) members 203 do not create the project as it is already created by members 201 in action 102, and (2) members 203 use the tools of software 212 to create and define responses 404 instead of requirements 402. After creating responses 404 to requirements 402, members 203 create links between responses and requirements using a tool 244 named “Linkage”. Members 201 can similarly create links between the responses and requirements after members 203 create responses 404.

In action 2050 (FIG. 20A), the user selects a node from requirement tree 1008. In action 2051, server computer 206 reads data of the selected node from one or more databases 210. In action 2052, a user selects tool 244. For example, the user selects a button 2002 (FIG. 22) to access tool 244. In action 2053, server computer 206 generates and transmits a web page 2004 (FIG. 20B) to client computer 202I. Web page 2004 includes a requirement tree 1008 indicating the selected node, a corresponding response tree 2008 created by members 203 in the same fashion as requirement tree 1008, and a list of responses linked to a selected requirement.

In action 2054, the user links one or more responses to one or more requirements. For example, the user selects a node of tree 1008, right click a node of tree 2008 to bring up a menu, and then selects a command to link the selected node of tree 2008 to the selected node of tree 1008. The user can also de-links one or more responses to one or more requirements. For example, the user selects a node in tree 1008, a box alongside a corresponding response in list 2010, and then a de-link button 2014. In action 2055, server computer 206 updates record 822 in one or more databases 210. In action 2056, the user can set a compliance level (e.g., partial and full) between a pair of linked response and requirement to indicate the degree that the response is providing what the requirement specifies. For example, the user selects the compliance level via a drop down list 2012. Table 14 provides the file names of software on client computer 202I (e.g., ASP pages and ActiveX controls) and server computer 206 (e.g., classes of COM components) that performs the above actions.

TABLE 14

| Action | Client computer | Server computer |
|---|---|---|
| 2050 | Orchtree.ctl | |
| 2051 | | OrchTree.cls |
| 2052 | N/A | |
| 2053 | | N/A |
| 2054 | Orchtee.ctl | |
| 2055 | | OrchTree.cls |
| 2056 | Orchtree.ctl | |
| 2057 | | OrchTree.cls |

In preparation of this application, the above reference file names and directories that contain the file names have been changed in conformance with the requirement of USPTO in filing computer appendices. The following table shows the changes to the file and directory names.

TABLE 15

| Original | | New | |
|---|---|---|---|
| Directory | Original File Name | Directory | New File Name |
| ASP Files | Sysengg.asp | ASPFILES | Sysengg.asp |
| ASP Files | Orch_Workflow.asp | ASPFILES | Orchwkfw.asp |
| ASP Files | ProjectEstimate.asp | ASPFILES | Projestm.asp |
| ASP Files | Notes.asp | ASPFILES | Notes.asp |
| ASP Files | RFICal.asp | ASPFILES | RFICal.asp |
| ASP Files | RFIDesc.asp | ASPFILES | RFIDesc.asp |
| ASP Files | RFIform.asp | ASPFILES | RFIform.asp |
| ASP Files | Orchdocument- | ASPFILES | ordefldr.asp |
| | folder.asp | | |
| ASP Files | Adddocument.asp | ASPFILES | Adddoc.asp |
| ASP Files | Orchdocument- | ASPFILES | Ordocsm.asp |
| | foldersm.aso | | |
| ASP Files | Editdocument.asp | ASPFILES | Editdoc.asp |
| ASP Files | Viewdocument.asp | ASPFILES | Viewdoc.asp |
| ASP Files | Obstoadduser.asp | ASPFILES | Obsadusr.asp |
| ASP Files | Notification.asp | ASPFILES | Notif.asp |
| ASPInterface | Phases.cls | Aspintfc | Phases.cls |
| ASPInterface | ProjEstimate.cls | Aspintfc | Projestm.asp |
| ASPInterface | Notes.cls | Aspintfc | Notes.cls |
| ASPInterface | RFI.cls | Aspintfc | RFI.cls |
| ASPInterface | Documents.cls | Aspintfc | Docmnt.cls |
| ASPInterface | Rules.cls | Aspintfc | Rules.cls |
| ASPInterface | Corporate.cls | Aspintfc | Corp.cls |
| ASPInterface | CreateProject.cls | Aspintfc | Crtproj.cls |
| ASPInterface | Notification.cls | Aspintfc | Notif.cls |
| ASPInterface | ProjUserMgmt.cls | Aspintfc | Projusmg.cls |
| ASPInterface | Registration.cls | Aspintfc | Regist.cls |
| ASPInterface | Conference.cls | Aspintfc | Conf.cls |
| BkGrndProcess | ClsMsmq.cls | Bckgrnpc | ClsMsmq.cls |
| BkGrndProcess | OrchEngine.cls | Bckgrnpc | OrchEng |
| DBScript | | Dbscrpt | |
| MSMQServer | | Msmqsrv | |
| OrchEng | | Orcheng | |
| OrchestraClient | OrchTree.ctl | Orchclnt | OrchTree.ctl |
| OrchestraClient | Domainlist.ctl | Orchclnt | Domlist.ctl |
| OrchestraClient | RiskMgmt.ctl | Orchclnt | RiskMgmt.ctl |
| OrchestraClient | Descriptors.ctl | Orchclnt | Desc.ctl |
| OrchestraClient | Obs.ctl | Orchclnt | Obs.ctl |
| OrchestraKernel | Nodes.cls | Orchkrnl | Nodes.cls |
| OrchestraKernel | Documents.cls | Orchkrnl | Documents.cls |
| OrchestraKernel | Globals.cls | Orchkrnl | Globals.cls |
| OrchestraKernel | Commons.cls | Orchkrnl | Commons.cls |
| OrchestraUtil | CustReport.cls | Orchutil | Custrep.cls |
| OrchestraUtil | Export.cls | Orchutil | Export.cls |
| OrchestraUtil | Import.cls | Orchutil | Import.cls |
| OrchestraUtil | OutLine.cls | Orchutil | OutLine.cls |
| OrchestraUtil | Reports.cls | Orchutil | Reports.cls |
| REG files | | Regfile | |
| Setup-upgrade | | Stupgr | |
| XInterface | OrchTree.cls | xintfc | OrchTree.cls |
| XInterface | RiskMgmt.cls | xintfc | RiskMgmt.cls |
| XInterface | SysAlloc.cls | xintfc | SysAlloc.cls |
| XInterface | Descriptors.cls | xintfc | Desc.cls |
| XInterface | Linkage.cls | xintfc | Linkage.cls |
| XInterface | OBS.cls | xintfc | OBS.cls |

Although the invention has been described with reference to particular embodiments, the description is only of examples and should not be taken as a limitation. Although the states, methods, and actions therein may be described in a particular order, they can occur in multiple orders. For example in state 310, the user may assign the security level before the domain. Furthermore, some of the actions may be bypassed. For example, the user may not provide a description for the risk or the mitigation. Various other adaptations and combinations of features of the embodiments disclosed are within the scope of the invention as defined by the following claims.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving registration information including a list of users;
creating a node in a hierarchical tree of project requirements, wherein the node of the hierarchical tree of project requirements includes a domain name associated with a domain that defines a specialty area or subject matter associated with the node;
assigning users from the list of users to the node, wherein users of the list of users assigned to the node are associated with a responsibility and arranged in a hierarchical tree of roles;
receiving a response to the requirement associated with the node;
creating a link between the requirement and response;
wherein creating the link automatically links the response to a user based on the role associated with the user.

2. The method of claim 1, further comprising receiving project information, wherein the project information includes a project identifier and a project description.

3. The method of claim 1, further comprising creating a project in association with the project information, and if a project owner of the project is not registered, creating a corporate account.

4. The method of claim 1, further comprising creating an organization breakdown structure associated with the project, wherein each user assigned to the node is associated with a role and arranged in a hierarchical tree of roles associated with the node.

5. The method of claim 1, further comprising developing a specification and a description of a project associated with the node.

6. The method of claim 1, further comprising sending a web page to a client computer after a user logs included in the list of users into a server computer, wherein the web page includes buttons for a user to add, delete, edit, export, and/or import data associated with the node.

7. The method of claim 1, further comprising sending a web page to a client computer after a user selects the node, wherein the web page includes a frame showing requirements or responses, an interface to a plurality of software, and notifications of messages to the user.

8. The method of claim 1, wherein the node is associated with a project, further comprising selecting a phase and associating a workflow process with the project, wherein the workflow process sends out alerts when manually triggered or automatically triggered by events specified by date, time, and action.

9. The method of claim 1, wherein the organization breakdown structure includes a user's access and modification rights.

10. The method of claim 1, further comprising identifying, reviewing, or mitigating a risk associated with the requirement.

11. The method of claim 1, further comprising estimating costs of a project based on an estimate provided for the node in the hierarchical tree of project requirements.

12. The method of claim 1, further comprising coordinating or reviewing conferences associated with the node.

13. The method of claim 1, further comprising providing and managing a description, a specification, or a document in the node.

14. The method of claim 1, further comprising providing a compliance level for the response to indicate a degree to which the response meets the requirement.

15. A system comprising:
a server computer including a computer readable medium including a project management software;
a database storage;
a plurality of client computers;
wherein, in operation, a plurality of users exchange project requirements and responses by communicating using threaded and context-sensitive messages, the database storage saves project related data including the project requirements and the responses under a plurality of hierarchical tree structures wherein the project requirements include tasks, milestones, deliverable items, procured items, and/or specifications, and the plurality of hierarchical tree structures include a project hierarchical tree and a organization hierarchical tree, wherein each of the users is assigned to a node in the organization hierarchical tree associated with a responsibility and arranged in a hierarchical tree of roles; and the server computer manages the database storage made accessible to the client computers using the project management software and controls data flow with client computers and the database storage, and links are made among data in the plurality of hierarchical trees based on relevance to the project requirements and communications among users so that linked data is searchable as an organized group.

16. The system of claim 15, wherein the project management software further includes a security and authority level control that limits a user's access to information stored in the database based on the security and authority level assigned to the user.

17. The system of claim 15, wherein data in the project hierarchical tree includes a domain name associated with a domain that defines a specialty area or subject matter associated with a node in the project hierarchical tree.

18. The system of claim 15, wherein data in the plurality of hierarchical tree structures include a risk and/or mitigations for the risk, wherein the risk is associated with at least one project requirement.

19. The system of claim 15, wherein data in the plurality of hierarchical tree structures include an estimate of cost to fulfill a project requirement.

20. A system comprising:
means for receiving a list of users;
means for creating a node in a hierarchical tree including one or more requirements for the node;
means for assigning a user from the list of users to the node;
means for receiving a response to a requirement associated with the node from the user;
means for creating a link between the requirement and the response.
